(19) United States
(12) Patent Application Publication
(10) Pub. No.: US 2026/0203741 A1
(43) Pub. Date: Jul. 16, 2026

(54) METHOD AND DEVICE FOR PAYMENT USING ULTRA-WIDEBAND

(71) Applicant: Samsung Electronics Co., Ltd., Suwon-si, Gyeonggi-do (KR)

(72) Inventors: Yeonju LIM, Suwon-si (KR); Sungdong KIM, Suwon-si (KR); Youngsun RYU, Suwon-si (KR); Kisoo AN, Suwon-si (KR)

(21) Appl. No.: 19/128,949

(22) PCT Filed: Nov. 9, 2022
(86) PCT No.: PCT/KR2022/017568

§ 371 Date: May 9, 2025

(51) Int. Cl. G06Q 20/32; H04B 1/7163; H04W 4/021

(52) U.S. Cl. CPC G06Q 20/325; H04B 1/7163; H04W 4/022

(57) ABSTRACT

The present disclosure provides a method for UWB-based safe proximity payment. A method of a first electronic device for processing payment using UWB communication may comprise the steps of: broadcasting a first signal including a UWB advertisement message including information on a threshold value related to a signal strength; receiving a second signal including a UWB response message from at least one second electronic device; measuring an AoA for the received second signal, and performing UWB TWR on the basis of the UWB response message included in the second signal to identify a distance between the first electronic device and the at least one second electronic device; determining a pay-zone on the basis of the AoA and the distance between the first electronic device and the at least one second electronic device; and transmitting a third signal including information on payment to one or more second electronic devices included in the pay-zone from among the at least one second electronic device.

### TECHNICAL FIELD

The disclosure relates to ultra wide band (UWB) communication, and a short-distance payment method and apparatus for a plurality of users using a UWB.

### BACKGROUND ART

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched.

Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

With the advance of wireless communication systems, various services can be provided, and accordingly there is a need for ways to effectively provide these services. For example, a ranging technology for measuring the distance between electronic devices by using an ultra wide band (UWB) may be used.

### DETAILED DESCRIPTION OF THE INVENTION

### Technical Problem

The disclosure provides a method capable of performing safe proximity payment for a plurality of users using a UWB.

The disclosure provides a safe and high-convenient payment method for a service provided by an unmanned terminal.

### Technical Solution

A method of a first electronic device for processing payment using UWB communication according to various embodiments of the disclosure may include broadcasting a first signal including a UWB advertisement message including information on a threshold value related to signal strength, wherein the UWB advertisement message is used as a UWB initiation message for initiating UWB two-way ranging (TWR), receiving, from at least one second electronic device, a second signal including a UWB response message, measuring an angle of arrival (AoA) for the received second signal and performing UWB TWR, based on the UWB response message included in the second signal, so as to identify a distance between the at least one second electronic device and the first electronic device, determining a pay-zone, based on the distance between the at least one second electronic device and the first electronic device, and the AoA, and transmitting, to one or more second electronic devices included in the pay-zone among the at least one second electronic device, a third signal including information related to the payment.

A method of a second electronic device for processing payment using UWB communication according to various embodiments of the disclosure may include receiving, from a first electronic device, a first signal including a UWB advertisement message including information on a threshold value related to signal strength, wherein the UWB advertisement message is used as a UWB initiation message for initiating UWB two-way ranging (TWR), measuring an angle of arrival (AoA) and the signal strength, based on the first signal, determining whether the measured signal strength is larger than the threshold value related to the signal strength, in case that the signal strength is larger than the threshold value related to the signal strength, transmitting a second signal including a UWB response message to the first electronic device, receiving a third signal including the information related to the payment from the first electronic device, and determining whether to perform the payment, based on the information related to the payment.

### Advantageous Effects

It is possible to increase security of proximity payment according to a proximity payment method of the disclosure.

Further it is possible to increase accessibility and convenience when a plurality of users uses proximity payment according to the proximity payment method of the disclosure and a UWB message.

### BRIEF DESCRIPTION OF DRAWINGS

FIG. 1 illustrates the exemplary architecture of a UWB device according to an embodiment of the disclosure.

FIG. 2A illustrates an exemplary configuration of a communication system including an electronic device supporting a UWB-based service according to an embodiment of the disclosure.

FIG. 2B illustrates an exemplary configuration of a communication system including an electronic device supporting a UWB-based service according to an embodiment of the disclosure.

FIG. 3 illustrates an exemplary configuration of a framework included in an electronic device supporting a UWB-based service according to an embodiment of the disclosure.

FIG. 4 illustrates a proximity payment method through short-range communication according to an embodiment of the disclosure.

FIG. 5 illustrates a proximity payment method through secure ranging according to an embodiment of the disclosure.

FIG. 6 illustrates a phase of a proximity payment method through short-range communication according to an embodiment of the disclosure.

FIG. 7 illustrates a method of determining the location of an electronic device through short-range communication according to an embodiment of the disclosure.

FIG. 8A illustrates a phase of a proximity payment method of an electronic device according to an embodiment of the disclosure.

FIG. 8B illustrates a method of determining a pay-zone according to an embodiment of the disclosure.

FIG. 8C illustrates another method of determining the pay-zone according to an embodiment of the disclosure.

FIG. 9 illustrates a format of a UWB advertisement message according to an embodiment of the disclosure.

FIG. 10A illustrates the phase of the proximity payment method of an electronic device according to another embodiment of the disclosure.

FIG. 10B illustrates a method of determining a payer and a pay-zone according to an embodiment of the disclosure.

FIG. 11A illustrates the phase of the proximity payment method of the electronic device according to another embodiment of the disclosure.

FIG. 11B illustrates a method of determining a payer and a pay-zone according to an embodiment of the disclosure.

FIG. 12 is a diagram illustrating a structure of a first electronic device according to an embodiment of the disclosure.

FIG. 13 is a diagram illustrating a structure of a second electronic device according to an embodiment of the disclosure.

### MODE FOR CARRYING OUT THE INVENTION

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The instructions which execute on a computer or other programmable data processing apparatus to cause a series of operational steps to be performed on the computer or other programmable data processing apparatus to produce a computer implemented process may provide steps for implementing the functions specified in the flowchart block(s).

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, according to some embodiments, the “unit” may include one or more processors.

As used herein, the term “terminal” or “device” may also be referred to as a mobile station (MS), a user equipment (UE), a user terminal (UT), a wireless terminal, an access terminal (AT), a terminal, a subscriber unit, a subscriber station (SS), a wireless device, a wireless communication device, a wireless transmit/receive unit (WTRU), a mobile node, a mobile, or other terms. Various example of the terminal may include a cellular phone, a smartphone having a wireless communication function, a personal digital assistant (PDA) having a wireless communication function, a wireless modem, a portable computer having a wireless communication function, a photographing device, such as a digital camera, having a wireless communication function, a gaming device having a wireless communication function, a music storage and reproduction home appliance having a wireless communication function, an Internet home appliance capable of wireless Internet access and browsing, and portable units or terminals having integrated combinations of the above functions. Furthermore, the terminal may include a machine to machine (M2M) terminal, and a machine type communication (MTC) terminal/device, but is not limited thereto. In the specification, the terminal may also be referred to as an electronic device or simply as a device.

Hereinafter, the operation principle of the disclosure will be described in detail in conjunction with the accompanying drawings. In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

Hereinafter, embodiments of the disclosure will be described in detail in conjunction with the accompanying drawings. In the following description of embodiments of the disclosure, a communication system (e.g., UWB communication system specified by FiRa Consotium) using a UWB will be described by way of example, but the embodiments of the disclosure may be applied to other communication systems having similar technical backgrounds or characteristics. Examples thereof may include communication systems using Bluetooth or Zigbee. Therefore, based on determinations by those skilled in the art, the embodiments of the disclosure may be applied to other communication systems through some modifications without significantly departing from the scope of the disclosure.

Also, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In general, a wireless sensor network technology is largely divided into a wireless local area network (WLAN) technology and a wireless personal area network (WPAN) technology according to the recognized distance. At this time, the WLAN corresponds to a technology based on IEEE 802.11 capable of accessing a backbone network within a radius of 100 m. Further, the WPAN corresponds to a technology based on IEEE 802.15 and may include Bluetooth, ZigBee, ultra wide band (UWB), and the like. A wireless network for implementing the wireless network technologies may include a plurality of electronic devices.

According to the definition of federal communications commission (FCC), the UWB may be a wireless communication technology using bandwidths higher than or equal to 500 MHz or in which bandwidths corresponding to the center frequency are 20% or more. The UWB may be a band itself to which UWB communication is applied. The UWB allows secure and accurate ranging between devices.
Specific terms used in the following description are provided to help understanding of the disclosure, and the use of the specific terms may be changed to other forms without departing from the scope of the technical idea of the disclosure.
An “application dedicated file (ADF)” may be a data structure within application data structure capable of hosting, for example, an application or application-specific data.

An “application protocol data unit (APDU)” may be a command and a response used for communication with application data structure within a UWB device.

“Application-specific data” may be, for example, a file structure having a root level and an application level including UWB controlee information and UWB session data required for a UWB session.

A “controller” may be a ranging device for defining and controlling ranging control messages (RCMs) (or control messages). The controller may define and control ranging features by transmitting a control message.

A “controlee” may be a ranging device using a ranging parameter within an RCM (or a control message) received from a controller. The controlee may use ranging features configured through the control message from the controller.

A “dynamic scrambled timestamp sequence (STS) mode” may be an operation mode in which the STS is not repeated for a ranging session unlike a “static STS”. In this mode, the STS may be managed by a ranging device and a ranging session key for generating the STS may be managed by a secure component.

An “applet” may be an applet executed on a secure component including UWB parameters and service data. The applet may be a FiRa applet.

A “ranging device” may be a device capable of performing UWB ranging. In the disclosure, the ranging device may be an enhanced ranging device (ERDEV) defined in IEEE 802.15.4z or a FiRa device. The ranging device may be referred to as a UWB device.

A “UWB-enabled application” may be an application for a UWB service. For example, the UWB-enabled application may be an application using a framework API for configuring an OOB connector, a secure service, and/or a UWB service for a UWB session. The “UWB-enabled application” may be abbreviated as an application or a UWB application. The UWB-enabled application may be a FiRa-enabled application.

A “framework” may be a component for providing access to a profile, an individual UWB configuration, and/or a notification. The “framework” may be a set (collection) of logical software components including, for example, a profile manager, an OOB connector, a secure service, and/or a UWB service. The framework may be a FiRa framework.

An “OOB connector” may be a software component for configuring an out-of-band (OOB) connection (for example, a BLE connection) between ranging devices. The OOB connector may be a FiRa OOB connector.

A “profile” may be a predefined set of a UWB and an OOB configuration parameter. The profile may be a FiRa profile.

A “profile manager” may be a software component for implementing a profile available by a ranging device. The profile manager may be a FiRa profile manager.

A “service” may be implementation of a use case for providing a service to an end-user.

A “smart ranging device” may be a ranging device capable of implementing an optional framework API. The smart ranging device may be a FiRa smart device.

A “global dedicated file (GDF)” may be a root level of application-specific data including data required for configuring a USB session.

A “framework API” may be an API used by a UWB-enabled application for communication with a framework.

An “initiator” may be ranging device initiating a ranging exchange. The initiator may initiate ranging exchange by transmitting a first RFRAME (ranging exchange message).

An “object identifier (OID)” may be an identifier of an ADF within an application data structure.

“Out-of-band (OOB)” is underlying wireless technology and may be data communication that does not use a UWB.

A “ranging data set (RDS)” may be data (for example, a UWB session key, a session ID, or the like) required for configuring a UWB session required to protect confidentiality, authenticity, and integrity.

A “responder” may be a ranging device transmitting a response to an initiator in a ranging exchange. The responder may respond to the ranging exchange message received from the initiator.

An “STS” may be a ciphered sequence for increasing integrity and accuracy of ranging measurement timestamps. The STS may be generated from a ranging session key.

A “secure channel” may be a data channel for preventing overhearing and tempering.

A “secure component” may be an entity (for example, an SE or a TEE) having a defined security level which interfaces with a UWBS in order to provide an RDS to the UWBS when, for example, a dynamic STS is used.

The “SE” may be a tamper-resistant secure hardware component which can be used as a secure component within a ranging device.

“Secure ranging” may be ranging based on an STS generated through a robust ciphering operation.

A “secure service” may be a software component for interfacing with a secure component such as a secure element or a TEE.

A “service applet” may be an applet on a secure component handling a service-specific transaction.

“Service data” may be data defined by a service provider, which is required to be transmitted between two ranging devices in order to implement a service.

A “service provider” may be an entity for defining and providing hardware and software required for providing a specific service to an end-user.

A “static STS mode” is an operation mode in which an STS is repeated during a session and does not need to be managed by a secure component.

A “secure UWB service (SUS) applet” may be an applet on an SE communicating with an applet in order to search for data required for enabling a secure UWB session with another ranging device. Further, the SUS applet may transmit corresponding data (information) to a UWBS.

A “UWB service” may be a software component providing access to a UWBS.

A “UWB session” may be a time period from the start of communication between a controller and a controlee through a UWB to the stop of the communication. The UWB session may include ranging, data transmission, or both the ranging and the data transmission.

A “UWB session ID” may be an ID (for example, an 32-bit integer) for identifying a UWB session shared between a controller and a controlee.

A “UWB session key” may be a key used for protecting a UWB session. The UWB session key may be used to generate an STS. The UWB session key may be a UWB ranging session key (URSK) and may be abbreviated as a session key.

A “UWB subsystem (UWBS)” may be a hardware component implementing a UWB PHY and MAC specifications. The UWBS may have an interface for a framework and an interface for a secure component for searching for an RDS.
“Scheduling-based ranging (scheduled based ranging)” may be used for ranging round scheduled by the controller to transmit a ranging frame (RFRAME) and/or a measurement report in different ranging slots by controlees. The scheduling-based ranging may be referred to as time-scheduled ranging. A scheduling mode using the scheduling-based ranging may be referred to as a time-scheduled mode. For example, time-scheduled two way ranging may be used as the scheduling-based ranging.

“Contention-based ranging” may be used when the controller does not know MAC addresses of controlees participating in a UWB session (ranging session). In the contention-based ranging, the controller may be an initiator and perform ranging with an unknown UWB device. A scheduling mode using the contention-based ranging may be referred to as a contention-based mode.

In the contention-based ranging, the controller may determine the size of a contention access period (CAP), and the contention-based ranging may be used for ranging round informing of the CAP size through a ranging control message. The CAP may be referred to as a contention window or a contention window period.

In a contention-based mode (for example, contention-based two way ranging), the UWB device may operate as the controller and the initiator, in which case a ranging control phase (RCP) and a ranging initiation phase (RIP) may be integrated into one phase (for example, RIP). In a ranging phase (RP), for allocation of the CAP size, the CAP period for responder(s) participating in the corresponding ranging round may be determined in units of ranging slots. Each responder may randomly determine one slot within the CAP in order to transmit a ranging response message (RRM). Messages used in the contention-based ranging may use SPI as an RFRAME configuration.
“Hybrid ranging” may be used when there is a known controlee and an unknown controlee. As described above, the known controlee may be a controlee of which the MAC address is known by the controller, and the unknown controlee may be a controlee of which the MAC address is not known by the controller. The hybrid ranging may be referred to as hybrid-based ranging. A scheduling mode using the hybrid ranging may be referred to as a hybrid-based mode.

In the hybrid-based mode, the controller may perform ranging with the known controlee in the scheduling-based mode and with the unknown controlee in the contention-based mode.

In the hybrid-based mode, the ranging round may include a ranging control phase (RCP) and a ranging phase (RP). The RP may include a contention free period (CFP) for scheduling-based ranging (access) and a contention access period (CAP) for contention-based ranging (access). A control message (ranging control message) used in the RCP of the hybrid-based mode may be referred to as ranging management message (RMM).

A “UWB message” may be a message including a payload IE transmitted by the UWB device (for example, ERDEV). The UWB message may be a message, for example, a ranging initiation message (RIM), a ranging response message (RRM), a ranging final message (RFM), a control message (CM), a measurement report message (MRM), a ranging result report message (RRRM), a control update message (CUM), or a one-way ranging (OWR) message. As necessary, a plurality of message may be integrated into one message.

A “payload IE” may be called a payload information element and may be included in a MAC payload of a UWB MAC frame defined in IEEE 802.15.4/4z. The MAC payload may include a plurality of payload IEs.

A “data message IE (data message payload IE)” may be an additional payload IE for transmitting application data. The application data may be data transmitted from a higher framework or application of the UWB MA layer.

The data message IE may be used during a two-way ranging (TWR) procedure. In this case, the ranging message (UWB message) may include at least one or both of the payload IE for ranging and the data message IE for transmitting application data. For example, the data message IE may be transmitted while being included as a part of the payload IE of the MAC payload of a ranging initiation message (RIM), a ranging response message (RRM), a ranging final message (RFM), a measurement report message (MRM), and a ranging result report message (RRRM) for ranging.

The data message IE may be used during a one-way ranging (OWR) procedure for angle of arrival (AoA) measurement. In this case, the AoA measurement message may include at least one or both of the payload IE for AoA measurement and the data message IE for transmitting application data. For example, the data message IE may be transmitted while being included as a part of the payload IE of the MAC payload of the AoA measurement message.

The “OWR” may be a ranging method using messages transmitted in one direction between the ranging device and one or more different ranging devices. The OWR may be used to measure time difference of arrival (TDoA). In addition, the OWR may be used to measure the AoA on the receiving side rather than measuring the TDoA. In this case, a pair of one advertiser and one observer may be used. The OWR for measuring the AoA may allow the observer to receive an OWR message from the advertiser and allow the observer to measure the AoA to determine a user's intention, action, or motion. For example, the user's contention to control a specific advertiser may be verified by the result of AoA measurement for OWR messages from the advertiser. In the disclosure, the OWR may be referred to as a UWB OWR.

The “advertiser” is a ranging device transmitting an AoA measurement message. The advertiser may insert application data (application payload data) as a part of the MAC payload of the AoA measurement message by using the data message IE. The application data may be configured by an upper layer. In the disclosure, the advertiser may be referred to as an advertiser device or a UWB advertiser device. In the disclosure, the AoA measurement message may be referred to as an OWB message for AoA measurement, a UWB OWR message for AoA measurement, a UWB advertisement message, an advertisement message, or the like.

The “observer” is a ranging device which receives the AoA measurement message and measures the AoA for each message. The observer may transmit the measured AoA to the upper layer. When application data is included in the MAC payload of the AoA measurement message, the observer may transmit the same to the upper layer. In the disclosure, the observer may be referred as an observer device or a UWB observer device.

A “TWR” may be a ranging method capable of estimating a relative distance between two devices by measuring the time of flight (ToF) through exchange of ranging message between the two devices. The TWR method may be one of double-sided two-way ranging (DS-TWR) and single-sided two-way ranging (SS-TWR). The SS-TWR may be procedure in which ranging is performed through one round-trip time measurement. For example, the SS-TWR may include an operation of transmitting the RIM from the initiator to the responder and an operation of transmitting the RRM from the responder to the initiator. The DS-TWR may be procedure in which ranging is performed through two round-trip time measurement. For example, the DS-TWR may include an operation of transmitting the RIM from the initiator to the responder, an operation of transmitting the RRM from the responder to the initiator, and an operation of transmitting the RRM from the initiator to the responder. Through such ranging exchange (ranging message exchange), the time of flight (ToF) may be calculated and the distance between two devices may be estimated. Meanwhile, during the TWR procedure, measured AoA information (for example, AoA azimuth result and AoA elevation result) may be transferred to another ranging device through the RRM or another message. In the disclosure, the TWR may be referred to as UWB TWR.

“DL-TDoA may be called downlink time difference of arrival (DL-TDoA) or reverse TDoA and an operation in which a user device (tag device) overhears (or receives) a message of an anchor device during a process in which a plurality of anchor devices broadcasts messages or exchanges messages with each other may be a basic operation. The DL-TDoA may be classified as the type of one way ranging like the uplink TDoA. The user device performing the DL-TDoA may overhear a message transmitted by two anchor devices and calculate the TDoA that is proportional to the distance between each anchor device and the user device. The user device may calculate the distance relative to anchor devices by using the TDoA with several pairs of anchor devices and use the same for positioning. The operation of the anchor device for the DL-TDoA may include, for example, an operation similar to the DS-TWR defined in IEEE 802.15.4z, and may further include other useful time information to allow the user device to calculate the TDoA. The DL-TDoA may be referred to as DL-TDoA localization.

“Uplink TDoA (UL-TDoA)” may be a ranging method in which the UWB tag transmits (broadcasts) a ranging message to at least one UWB anchor and at least one UWB anchor receives TDoA, based on the received ranging message and estimates the location of the UWB tag, based on the TDoA.

“AoA” is an arrival angle of a received signal and may be expressed as a relative angle such as AoA azimuth and AoA elevation. For example, it may be assumed that a measurement device is an electronic device having a display, a Y axis is a vertical display axis of the electronic device, an X axis is a horizontal display axis of the electronic device, and a Z axis is orthogonal to the display of the electronic device. In this case, an AoA azimuth angle may be a relative angle between an input signal projected onto the XZ plane and the Z axis, and an AoA elevation angle may be a relative angle between the input signal and the XZ plane.

In the case of TWR, the controller (and/or initiator) may measure the AoA azimuth for the RRM and transfer the measured AoA azimuth to an upper layer through a UCI notification message. The controlee (and/or responder) may measure the AoA azimuth for the RIM message and transmit the measured AoA azimuth through the RRM.

In the case of TWR, the controller (and/or initiator) may measure the AoA elevation for the RRM and transfer the measured AoA elevation to an upper layer through a UCI notification message. The controlee (and/or responder) may measure the AoA elevation for the RIM message and transmit the measured AoA elevation through the RRM.

In the case of OWR, the observer may measure the AoA azimuth and the AoA elevation for the AoA measurement message.

In the description of the disclosure, if it is determined that a detailed description of a relevant known function or configuration makes the subject of the disclosure unclear, the detailed description is omitted.

Embodiments of the disclosure are described with reference to the accompanying drawings.

In the description of the disclosure, if it is determined that a detailed description of a relevant known function or configuration makes the subject of the disclosure unclear, the detailed description is omitted.

Various embodiments of the disclosure are described with reference to the accompanying drawings.

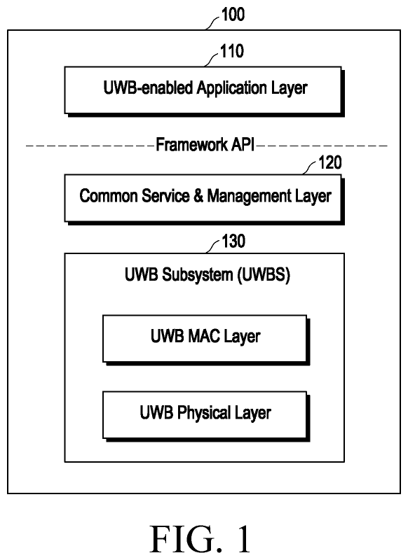

FIG. 1 illustrates the exemplary architecture of a UWB device according to an embodiment of the disclosure.

A UWB device 100 may be an electronic device supporting UWB communication. The UWB device 100 may be, for example, a ranging device supporting UWB ranging. In an embodiment, the ranging device may be an enhanced ranging device (ERDEV) defined in IEEE 802.15.4z or a FiRa device.

In the embodiment of FIG. 1, the UWB device 100 may interact with another UWB device through a UWB session.

Further, the UWB device 100 may implement a first interface (interface #1) which is an interface between a UWB-enabled application 110 and a UWB framework 120, and the first interface may allow the UWB-enabled application 110 in the UWB device 100 to use UWB capabilities of the UWB device 100 in a predetermined scheme. In an embodiment, the first interface may be a framework API or a proprietary interface, but is not limited thereto.

Further, the UWB device 100 may implement a second interface (interface #2) which is an interface between the UWB framework 110 and a UWB subsystem (UWBS) 130. In an embodiment, the second interface may be a UWB command interface (UCI) or a proprietary interface, but is not limited thereto.

Referring to FIG. 1, the UWB device 100 may include the UWB-enabled application 110, the framework (UWB framework) 120, and/or the UWBS 130 including a UWB MAC layer and a UWB physical layer. According to an embodiment, some entities may not be included in the UWB device or an additional entity (for example, security layer) may be further included.

The UWB-enabled application 110 may trigger a configuration of a UWB session by the UWBS 130 through the first interface. Further, the UWB-enabled application 110 may use one of the predefined profiles. The UWB-enabled application 110 may handle relevant events such as service discovery, ranging notifications, and/or error conditions through the first interface.

The framework 120 may provide access to a profile, an individual UWB configuration, and/or a notification. Further, the framework 120 may support at least one of a function for performing UWB ranging and transaction, a function for providing an interface for an application and the UWBS 130, or a function for estimating a location of the device 100. The framework 120 may be a set of software components. As described above, the UWB-enabled application 110 may interface with the framework 120 through the first interface, and the framework 120 may interface with the UWBS 130 through the second interface.

Meanwhile, in the disclosure, the UWB-enabled application 110 and/or the framework 120 may be implemented by an application processor (AP) (or processor). Accordingly, in the disclosure, it may be understood that the operation of the UWB-enabled application 110 and/or the framework 120 may be performed by the AP (or processor). In the disclosure, the framework may be referred to as an AP or a processor.

The UWBS 130 may be a hardware component including a UWB MAC layer and a UWB physical layer. The UWBS 130 may manage a UWB session and communicate with a UWBS of another UWB device. The UWBS 130 may interface with the framework 120 through the second interface and acquire security data from the secure component. In an embodiment, the framework (or application processor) 120 may transmit a command to the UWBS 130 through UCI, and the UWBS 130 may transfer a response to the instruction to the framework 120. The UWBS 130 may transfer a notification to the framework 120 through UCI.

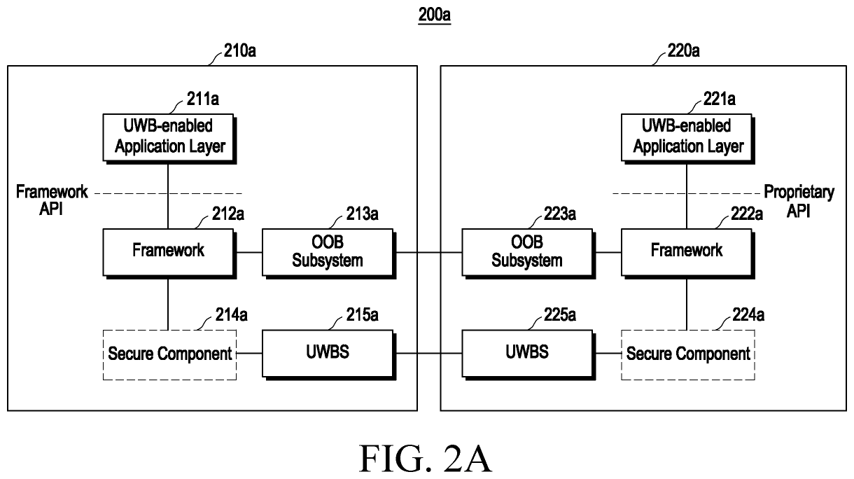

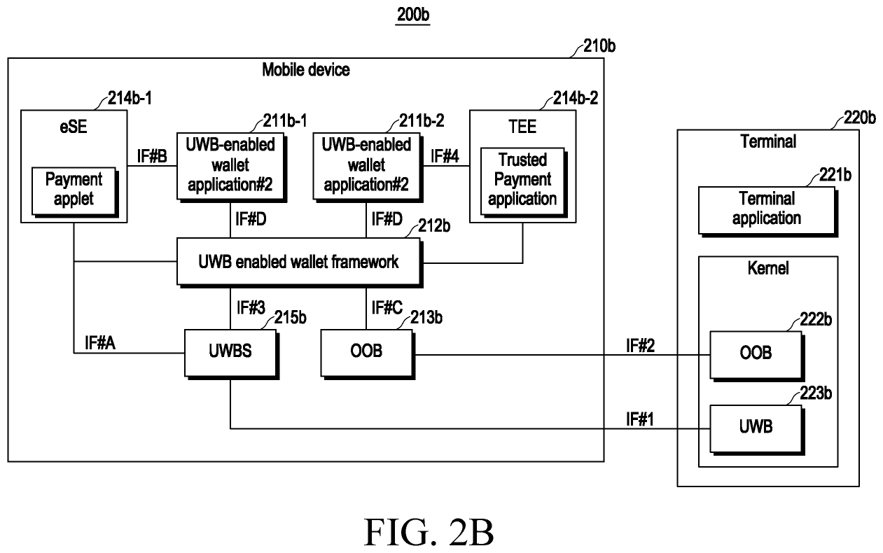

FIG. 2A illustrates an exemplary configuration of a communication system including an electronic device supporting a UWB-based service according to an embodiment of the disclosure.

Referring to FIG. 2A, a communication system 200a includes a first electronic device 210a and a second electronic device 220a.

As an embodiment, the first electronic device 210a and the second electronic device 220a may be, for example, the UWB device of FIG. 1 or electronic devices including the UWB device of FIG. 1. For example, the first electronic device 210a may be, for example, a smart ranging device or a ranging device, and the second electronic device 220a may be, for example, a ranging device or a ranging device. As an embodiment, the smart ranging device or the ranging device may be an enhanced ranging device (ERDEV) defined in IEEE 802.15.4z or a FiRa device. In FIG. 2A, the first electronic device may be referred to as a first UWB device, and the second electronic device may be referred to as a second UWB device.

The first electronic device 210a may host, for example, one or more UWB-enabled applications which can be installed by a user (for example, a mobile phone). This may be based on a framework API. The second electronic device 220a may use a proprietary interface to implement, for example, a specific UWB-enabled application that is provided by only a manufacturer without providing the framework API. Meanwhile, unlike FIG. 2, both the first UWB device and the second UWB device may be ranging devices using the framework API or both the first UWB device and the second UWB device may be ranging devices using the proprietary interface according to an embodiment.

The first electronic device 210a and the second electronic device 220a may include UWB-enabled application layers 211a and 221a, frameworks 212a and 222a, OOB components (OOB subsystems) 213a and 223a, secure components 214a and 224a, and/or UWBSs 215a and 225a, respectively. According to an embodiment, some components may be omitted or additional components may be further included.

The first electronic device 210a and the second electronic device 220a may generate an OBB connection (channel) through the OOB components 213a and 223a and generate a UWB connection (channel) through the UWBSs 215a and 225a to communicate with each other.

The frameworks 212a and 222a may serve to provide access to a profile, an individual UWB configuration, and/or a notification. The frameworks 212a and 222a are sets of software components and may include, for example, a profile manager, an OOB connector, a secure service, and/or a UWB service.

The OOB components 213a and 223a may be hardware components including a MAC layer and/or a physical layer for OOB communication (for example, BLE communication). The OOB components 213a and 223a may communicate with an OOB component of another device. In an embodiment, the first UWB device 210a and the second UWB device 220a may generate an OOB connection (channel) by using the OOB components 213a and 223a and exchange parameters for configuring a UWB session through the OOB channel. In the disclosure, the OOB components 213a and 223a may be referred to as an OOB subsystem.

The secure components 214a and 224a may be hardware components interfacing with the framework and/or the UWBS to provide the RDS. As an embodiment, the secure components 214a and 224a may be SE (for example, eSE), TEE (or a trusted application within TEE), or strongbox (SB).

The UWBSs 215a and 225a may be hardware components including a UWB MAC layer and a UWB physical layer. The UWBSs 215a and 225a may manage a UWB session and communicate with a UWBS of another UWB device. In an embodiment, the first UWB device 210a and the second UWB device 220a may perform UWB ranging and transaction of service data through the UWB session configured through the UWBSs 215a and 225a by using exchanged parameters.

In the disclosure, the UWB-enabled application layer and/or the framework may be implemented by an application processor (AP) (or processor). Accordingly, in the disclosure, the operation of the UWB-enabled application layer and/or the framework may be performed by an application processor (AP) (or processor).

FIG. 2B illustrates an exemplary configuration of a communication system including an electronic device supporting a UWB-based service according to an embodiment of the disclosure.

The embodiment of FIG. 2B may be one example of the embodiment of FIG. 2A.

In the embodiment of FIG. 2B, the UWB-based service may be a UWB-based payment service (wallet service). In the disclosure, embodiments of the disclosure are described based on the assumption that the UWB-based service is the UWB-based payment service, but embodiments of the disclosure may be applied to another type of UWB-based service.

Referring to FIG. 2B, the communication system 200b providing the UWB-based payment service may include a first electronic device 210b and a second electronic device 220b. In FIG. 2B, the first electronic device may be referred to as a first UWB device, and the second electronic device may be referred to as a second UWB device.

<First Electronic Device 210b>

The first electronic device 210b may be an electronic device of a user (for example, a mobile device of a user) for the UWB-based payment service. The first electronic device 210b may include at least one UWB-enabled wallet application (UWB-enabled application) 211b-1 and 211b-2, a UWB-enabled wallet framework (framework) 212b, an OOB component 213b, at least one secure component 214b-1 and 214b-2, and/or a UWBS 215b. For description of each component, refer to the description of FIG. 2A.

Meanwhile, in the embodiment of FIG. 2B, it is described that the UWB-enabled application corresponds to a UWB-enabled wallet application and the framework corresponds to a UWB-enabled wallet framework for convenience of description, but the embodiment is not limited thereto and various UWB-enabled applications and frameworks for providing various types of UWB-based service may be implemented. In FIG. 2B, the UWB-enabled wallet application may be referred to as a UWB-enabled application, a UWB-enabled payment application, or the like, and the UWB-enabled wallet framework may be referred to as a UWB-enabled payment framework, a framework, or the like.
(1) The UWB-enabled applications 211b-1 and 211b-2 may support at least one of the following features.
   hosts an applet (payment applet) for UWB-based payment within an embedded SE (eSE) or a trusted application (trusted payment application) for UWB-based payment within a TEE.
   when requested by the framework, provides deployment information of anchors for estimate the location of the first electronic device and/or a UWB block structure (for example, a ranging block structure).
   communicates with the second electronic device and a back-end server for personalization of the payment applet or the trusted payment application (TPA).
(2) The framework 212b may support at least one of the following features.
   estimates the location of the first electronic device.
   implements UCI commands.
   provides a set of APIs by which the UWB-enabled application approaches the UWBS and the OOB component.
(3) The OOB component 213b may support the following features.
   implements an OOB connection operation (for example, a BLE connection operation).
(4) The trusted payment application 211b-2 may be included in the TEE and may support at least one of the following features.
   supports a TEE client API.
   implements a trusted application.
   implements a secure channel protocol to communicate with the second electronic device in a secure manner.
   hosts payment credential and cryptographic keys for a secure channel.
   hosts important information (for example, card information) for supporting the UWB-based payment service.
(5) The payment applet 211b-1 may be included in the SE (eSE) and may support at least one of the following features.
   supports a APDU.
   implements a secure channel protocol to communicate with the second electronic device in a secure manner.
   hosts payment credential and cryptographic keys for a secure channel.
   hosts important information (for example, card information) for supporting the UWB-based payment service.

Each element of the first electronic device 210b may communicate with another element through a predefined interface (IF). Hereinafter, each interface is described.
IF #1: interface between the UWBS 215b of the first electronic device 210b and a UWBS of another electronic device (for example, the UWBS 223b of the second electronic device 220b). IF #1 may be used to exchange a UWB message and/or payment transaction.
IF #2: interface between the OOB component 213b of the first electronic device 210b and an OOB component of another device (for example, the OOB component 222b of the second electronic device 220b). IF #2 may be used to exchange an OOB message.
IF #3: interface between the framework 212b and the UWBS 215b. IF #3 may be used to exchange a UCI message. For example, IF #3 may be used to exchange a UCI message (for example, a UCI command/UC notification or the like) for configuring a secure channel between the trusted payment application 211b-2 and the UWBS 215b.
IF #4: interface between the UWB-enabled application 211b-2 and the trusted payment application 211b-2 within the TEE. IF #4 may be used to exchange TEE commands through the TEE client API. For example, IF #4 may be used to exchange TEE commands for configuring a secure channel between the trusted payment application 211b-2 and the UWBS 215b.
IF #A: interface between the UWB-enabled application 211b-1 and 211b-2 and the UWB 215b. IF #A may be, for example, a SUS external API.
IF #B: interface between the UWB-enabled application 211b-2 and the payment application 214b-1 within the SE (eSE). IF #B may be used to exchange a APDU through an object management application programming interface (OMAPI). For example, IF #B may be used to exchange an APDU for configuring a secure channel between the eSE and the UWBS.
IF #C: interface between the OOB component 213b and the framework 212b or the UWB-enabled application 211b-1 and 211b-2. For example, IF #C may be a host controller interface (HCI).
IF #D: interface between the UWB-enabled application 211b-1 and 211b-2 and the framework 212b. IF #D may be an API (framework API) provided by the framework 212b.

Meanwhile, although not illustrated in FIG. 2B, an interface between the TA (for example, trusted payment application) within the TEE 214b-2 and the UWBS 215b may be configured or defined to transmit an RDS including a UWB session key. In this case, in order to protect the interface between the TEE and the UWBS 215b, a secure channel between the TA and the UWBS 215b may be configured. Further, it is possible to connect the TA and the UWBS 215b at an HW level by newly configuring a driver TA.

<Second Electronic Device 220b>

The second electronic device 220b may be an electronic device (for example, a payment terminal (for example, a point of service (POS) terminal of retail) of a business person for the UWB-based payment service. The second electronic device 220b may include a terminal application 221b, an OOB component 222b, and/or a UWBS 223b. As an embodiment, the terminal application 221b may be a UWB-enabled application.

According to an embodiment, not only the user device for the UWB-based payment service, but also the payment terminal may have the same configuration as the configuration of the first electronic device 220b.

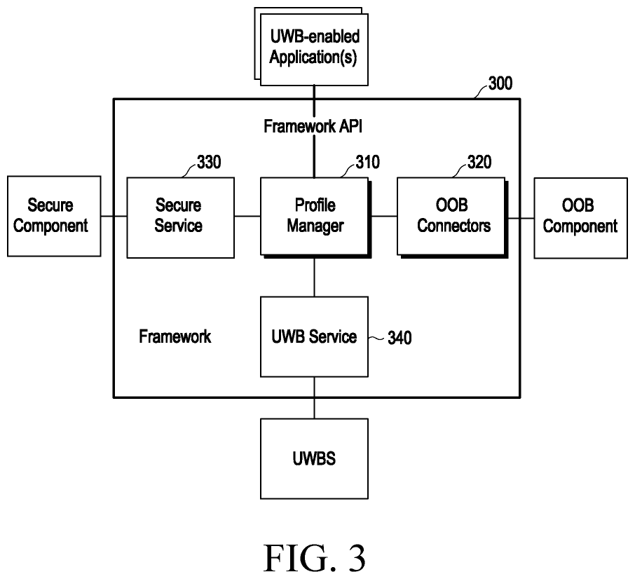

FIG. 3 illustrates an exemplary configuration of a framework included in an electronic device supporting a UWB-based service according to an embodiment of the disclosure.

A framework 300 of FIG. 3 may be an example of the framework of FIGS. 2A and 2B. The framework 300 of FIG. 3 may be, for example, a FiRa framework. The framework 300 may be a set of logical software components. The UWB-enabled application may interface with the framework through a framework API provided by the framework 300.

Referring to FIG. 3, the framework 300 may include a profile manger 310, an OOB connector 320, a secure service 330, and/or a UWB service 340. However, according to an embodiment, some components may be omitted or additional components may be further included.

The profile manager component 310 may manage profile(s) that can be used in a ranging device (UWB device). The profile may be a set of parameters required to establish a successful UWB session between ranging devices (UWB devices). For example, the profile may include a parameter indicating which secure channel (for example, OOB secure channel) is used, a UWB/OOB configuration parameters, a parameter indicating whether the use of a specific secure component is mandatory, and/or a parameter related to a file format of an ADF. Further, the profile manager may abstract UWB and OOB configuration parameters from the UWB-enabled application.

The OOB connector component 320 may be a component for configuration the OOB connection between ranging devices (UWB devices).

The secure service component 330 may serve to interface with a secure component such as a secure element (SE) or a trusted execution environment (TEE). The secure component may be a component interfacing with the UWB in order to transfer UWB ranging data to the UWBS.

Hereinafter, embodiments of a UWB-based safe proximity payment method are described with reference to each drawing.

When proximity payment based on the distance between an electronic device of a user (user device) (for example, a mobile device of a user) and a payment device (payment terminal) (for example, a point of sales (POS) terminal) is performed, there may be a problem in reliability of payment. For example, compromised payment (for example, payment between a user (or a user device) which is not within a real pay-zone and the payment terminal) may be performed by fabrication of the distance by an attacker rather than intended payment (for example, payment between the user (or the user device) within the real pay-zone and the payment terminal).

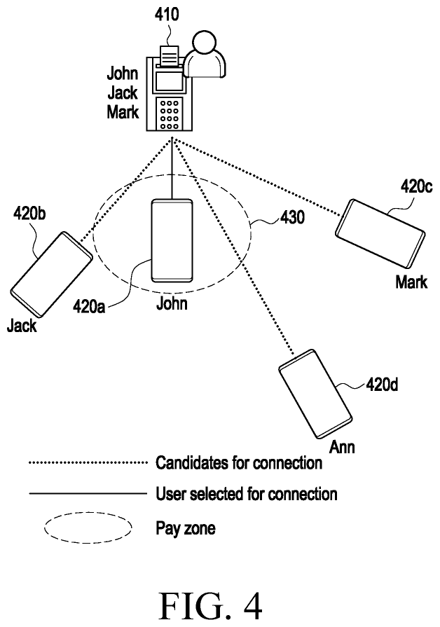

FIG. 4 illustrates a proximity payment method through short-range communication according to an embodiment of the disclosure.

In the embodiment of FIG. 4, it is assumed that a communication scheme between electronic devices is UWB communication. However, the communication scheme is not limited to UWB communication, and other communication schemes (for example, ZigBee, NFC, OOB, and the like) having the same or similar functions may be applied.

Referring to FIG. 4, a proximity payment method using UWB communication may need to configure a UWB connection (communication channel) between a user (a person to make payment) 420a to process real payment among a plurality of users 420a, 420b, 420c, and 420d that can communicate with a payment terminal (for example, a kiosk) 410 and the payment terminal. In the disclosure, the user may be used to refer to an electronic device of the user. That is, in the disclosure, the user and the user device may be interchangeably used. In the disclosure, the person to make payment may be used to refer to the electronic device 420a of the user to make real payment. That is, in the disclosure, the person to make payment and the electronic device of the user to make payment may be interchangeably used.

As illustrated in FIG. 4, the plurality of electronic devices 420a, 420b, 420c, and 420d may be designated as candidates to make the connection with the payment terminal 410. At least one electronic device 420a among the plurality of electronic devices 420a, 420b, 420c, and 420d may make the connection with the payment terminal 410. According to an embodiment, the connected electronic device 420a may be a terminal included in a randomly determined pay-zone 430.

In an embodiment, the person 420a to make payment is a user of the intended payment, for example, a user who is the closest to the payment terminal 410 or on the front of a predetermined payment line, a user performing checkout, a user within a predetermined area (for example, the pay-zone) 430, or a user who meets two or more of the corresponding conditions (for example, a user who is the closest to the payment terminal or on the front of the predetermined payment line and performs checkout, a user who performs checkout and is within the pay-zone, or the like).

In such a situation, when the plurality of electronic devices 420a, 420b, 420c, and 420d is located around the payment terminal 410, it is required to provide a method of giving a priority of the connection to the person to make payment.

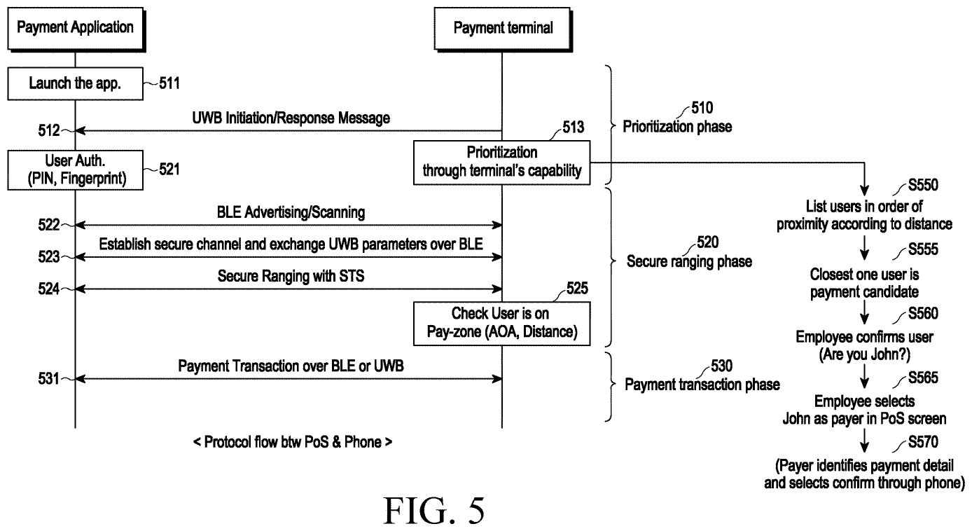

FIG. 5 illustrates a proximity payment method through secure ranging according to an embodiment of the disclosure.

In the embodiment of FIG. 5, secure ranging may be secure ranging using short-range communication of the disclosure. At this time, it is assumed that the short-range communication is UWB communication. However, the UWB communication is not limited thereto, and other communication schemes having the same or similar functions may be applied.

Referring to FIG. 5, a proximity payment method may be performed between a payment application and a payment device (terminal). In an embodiment, the payment application may be an application included (or installed) in an electronic device of a user (user device). Accordingly, an operation of a payment application in the disclosure may be understood as an operation of the user device including the payment application.

In an embodiment, the user device may correspond to the first UWB device (or the second UWB device) of FIG. 2 or may be a UWB device including some or all of the elements of the first UWB device (or the second UWB device). In an embodiment, the payment terminal may correspond to the second UWB device (or the first UWB device) of FIG. 2 or may be a UWB device including some or all of the elements of the second UWB device (or the first UWB device).

In an embodiment, the payment application and the payment terminal may be a UWB-enabled application and a UWB-enabled terminal including a payment transaction function, respectively.

In the embodiment of FIG. 5, the proximity payment method may include a prioritization phase 510, a secure ranging phase 520, and/or a payment transaction phase 530. Hereinafter, each phase is described.

### Prioritization Phase

The prioritization phase 510 may be a phase for determining priorities of users (or user devices) for proximity payment. In an embodiment, the prioritization phase 510 may include an operation 511 of launching the payment application of the user device, an operation 512 of transmitting and receiving (ranging) a UWB initiation/response message between the payment application and the payment terminal, and/or an operation 513 of prioritizing according to the performance of the payment terminal.

In an embodiment, the ranging operation 512 may be an operation for measuring the distance/direction (angle) between electronic devices through a UWB communication scheme. For example, the ranging operation 512 may include an operation of transmitting and receiving a ranging initiation message and response message through a ranging frame (RFRAME) and an operation of acquiring distance information according to a preset ranging method or mode, based on information included in the ranging frame (for example, timestamp information).

In an embodiment, the initiation message may be a ranging initiation message (RIM) used for DS-TWR or SS-TWR.

In an embodiment, the response message may be a ranging response message (RRM) used for DS-TWR or SS-TWR.

In an embodiment, the prioritization operation 513 according to the performance of the payment terminal may be subdivided in the following ways. A plurality of electronic devices (users) may be listed in the order of proximity according to the distance from the payment terminal in S550. Among the plurality of electronic devices, one electronic device that is the closest to the payment terminal may be determined as a payment candidate in S555. When the payment candidate is determined, an employee may perform user confirmation on the corresponding payment candidate in S560. When it is identified that the payment candidate is a person to make payment through the user confirmation, the employee may select the corresponding payment candidate as a payer through a POS screen in S565. The selected payer may identify a payment detail through the electronic device and perform payment confirmation in S570.

### Secure Ranging Phase

The secure ranging phase 520 may be a phase for performing secure ranging for proximity payment.

In an embodiment, the secure ranging phase 520 may include a user authentication operation 521, a BLE advertising/scanning operation (discovery operation) 522, an operation 523 of configuring a secure channel and exchanging (or negotiating) UWB parameters through BLE, a UWB secure ranging operation 524 using a scrambled timestamp sequence (STS), and/or an operation 525 of checking whether the user is in the pay-zone.

In an embodiment, the user authentication operation 521 may be performed using, for example, a PIN number and/or a fingerprint.

In an embodiment, the discovery operation 522 is a procedure for discovering a UWB device (service) and may be performed through OOB communication (for example, BLE communication) or In-band communication (for example, UWB communication).

In an embodiment, the connection operation 523 may be a procedure of establishing a UWB channel or session through exchange of parameters for establishing the channel or session for UWB communication. In an embodiment, the exchanged UWB parameters may include a ranging session key (UWB ranging session key (URSK)).

In an embodiment, the UWB secure ranging operation 524 may perform a secured ranging operation using an STS generated from a session key (URSK) exchanged through the UWB parameter exchange operation 523. In this case, the session key is a key for protecting a UWB session (for example, a ranging session) and may be used to derive the STS.

In an embodiment, the operation 525 of checking whether the user is in the pay-zone may be performed using angle of arrival (AoA) and/or distance information. In an embodiment, the AoA and/or distance information may be acquired through the UWB secure ranging operation 524.

### Payment Transaction Phase

The payment transaction payment 530 may be a phase of transacting proximity payment. In an embodiment, the payment transaction phase 530 may include a payment transaction operation 531 using OOB (for example, BLE) communication or UWB communication.

When BLE communication is used, the payment transaction phase 530 may include an operation of transmitting and receiving a message (payment message) for payment transaction through an already generated BLE/UWB secure channel. In an embodiment, communication of the payment message may follow, for example, an application protocol data unit (APDU)-based electromagnetic wave (EMW) protocol.

When UWB communication is used, the payment transaction phase 530 may include an operation of transmitting and receiving a payment message including encrypted data using the data encryption key (data payload encryption key) derived from the UWB session key. In an embodiment, communication of the payment message may follow the APDU-based EMW protocol.

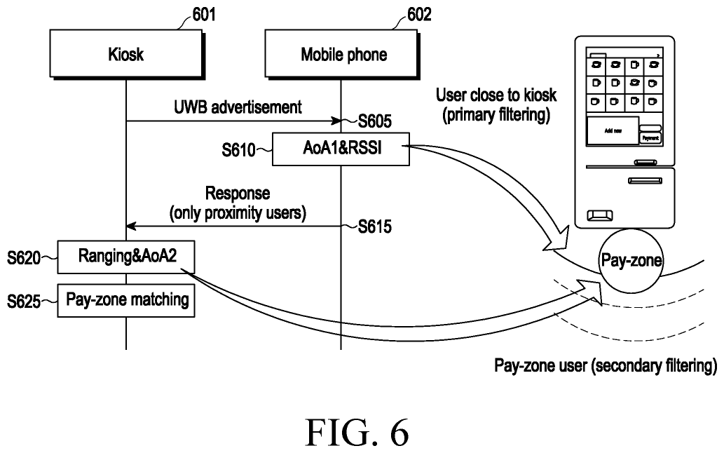

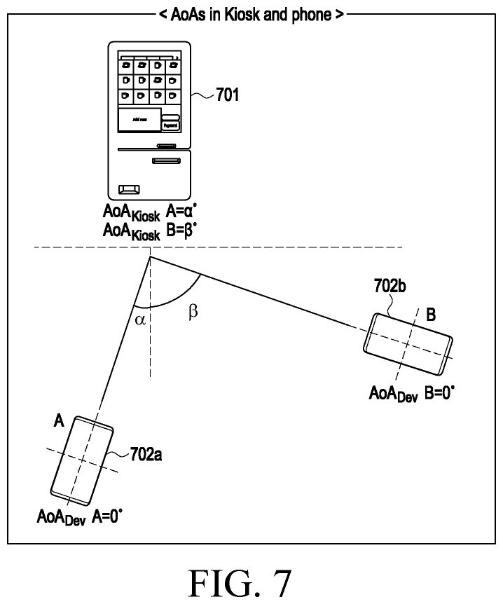

FIG. 6 illustrates a phase of a proximity payment method through short-range communication according to an embodiment of the disclosure. FIG. 7 illustrates a method of determining the location of an electronic device through short-range communication according to an embodiment of the disclosure.

The proximity payment method in the embodiment of FIG. 6 may be the proximity payment method of FIG. 5. A payment terminal 601 and at least one electronic device 602 of FIG. 6 may be the UWB electronic device of FIGS. 1 to 5.

A payment terminal 701 and at least one electronic device 702a and 702b in the embodiment of FIG. 7 may be the UWB electronic device of FIGS. 1 to 5 or may be the same as the payment terminal 601 and at least one electronic device 602 of FIG. 6.

The phase of the proximity payment method in the embodiment of FIG. 6 may be an example of the prioritization phase in the embodiment of FIG. 5. The phase of the proximity payment method may be performed between a payment terminal (for example, a kiosk) 601 and at least one electronic device (for example, a user terminal (user equipment), a phone, or the like) 602. In the embodiment of FIG. 6, the payment terminal 601 may be a UWB-enabled device, and at least one electronic device 602 may be UWB-enabled electronic devices.

The payment terminal 601 may transmit a UWB advertisement message to at least one electronic device 602 for communication with at least one electronic device 602 in S605. Instead of the UWB advertisement, a UWB initiation message (RIM) may be used to initiate UWB TWR.

At least one electronic device 602 receiving the UWB advertisement or UWB initiation message may measure an angle of arrival (AoA) and a strength (for example, a received signal strength indication (RSSI)) of a reliable signal (for example, line of sight (LoS) signal) through the received message in S610.

After determining the AoA and the strength (RSSI) of the signal from the payment terminal 601, at least one electronic device 602 may determine whether the determined AoA indicates a preset specific angle (for example, 0 degrees (0°)) (or is within a specific angle range (for example, −x degrees (for example, −1 degrees) to +x degrees (for example, +1 degrees)) and whether the strength of the signal is higher than or equal to a predetermined threshold value.

According to an embodiment, when the AoA measured by at least one electronic device 602 is 0 degrees, it may be identified that the corresponding electronic device exactly faces the payment terminal 601, which may be used to identify that the electronic device has an intention to pay other than determined due to reflection or refraction based thereon, Further, when the strength of the signal is higher than or equal to the predetermined threshold value, at least one electronic device 602 may determine how close the electronic device is to the payment terminal 601. According to an embodiment, the threshold value of the strength of the signal may be included in a UWB advertisement or UWB initiation message transmitted by the payment terminal 601 in S605. The UWB advertisement or UWB initiation message may include an indicator indicating transmission of a response message to at least one electronic device 602 when the measured strength of the signal is higher than or equal to the threshold value of the strength of the signal.

When the measured value of the strength of the signal is higher than the threshold value of the strength of the signal determined by the payment terminal 601 and the AoA is measured as 0 degrees, at least one electronic device 602 may transmit a response message to the payment terminal 601 in S615. The measured value of the strength of the signal may indicate information on the distance between the payment terminal 601 and the corresponding electronic device, and the AoA may indicate payment intention information of the corresponding electronic device.

When receiving the response message from at least one electronic device 602, the payment terminal 601 may perform ranging from each electronic device through the received response message and measure the AoA. The payment terminal 601 may perform ranging, so as to measure the distance between each electronic device transmitting the response message and the payment terminal 601. The payment terminal 601 may measure the angle of each electronic device transmitting the response message with respect to the payment terminal 601 through AoA measurement.

The payment terminal 601 may identify a predetermined pay-zone and determine a pay-zone, based on the measured AoA and ranging information in S625. According to an embodiment, information on the predetermined pay-zone may include information on a threshold value of the distance from the payment terminal 601 and a threshold value of the AoA. Accordingly, a predetermined distance and a predetermined angle from the payment terminal 601 may be determined as the pay-zone. In this case, the payment terminal 601 may compare ranging information and AoA information of each electronic device acquired through the received response message, based on the threshold value for the predetermined distance and the threshold value for the AoA and determine whether the electronic device is an electronic device corresponding to the pay-zone.

The payment terminal 601 may transmit information for payment to at least one electronic device included in the pay-zone.

Referring to FIG. 7, at least one electronic device 702a and 702b may measure the AoA, based on a message received from a payment terminal 701. When the measured AoA is 0°, at least one electronic device 702a and 702b may transmit a response message to the payment terminal 701. When the measured AoA is 0°, it may be determined that the corresponding electronic device has a payment intention. The payment terminal 701 may measure the AoA, based on the response message received from at least one electronic device 702a and 702b. Since the AoA measured by each electronic device is 0°, the payment terminal 701 may measure the AoA of each electronic device and at least one electronic device 702a and 702b transmitting the response message may measure an angle between the payment terminal 701 and the center. For example, it may be identified that the first electronic device 702a is spaced apart from the payment terminal 701 by α°, and the second electronic device 702b is spaced apart from the payment terminal 701 by β°.

The payment terminal 701 may determine whether each electronic device is included in the pay-zone, based on the measured AoA, through the method of FIG. 6 or may determine an electronic device to be included based on the measured AoA to determine the size of the pay-zone.

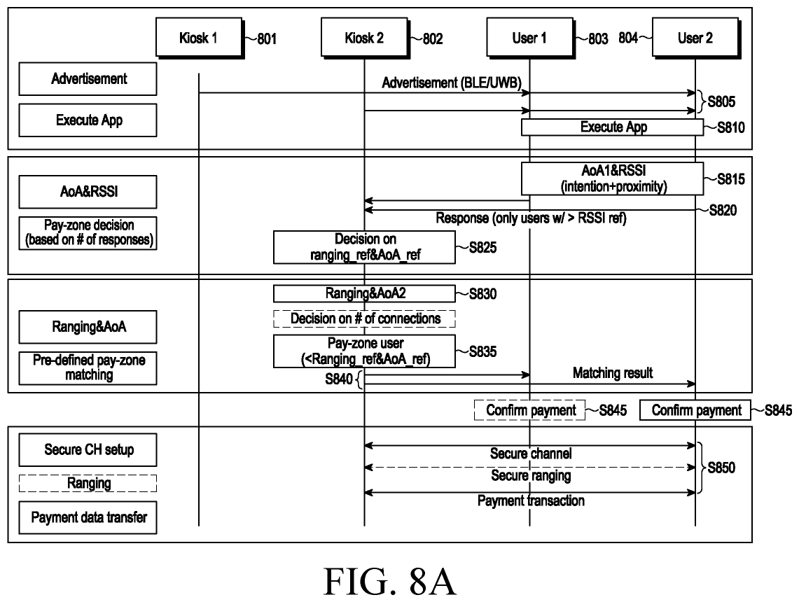

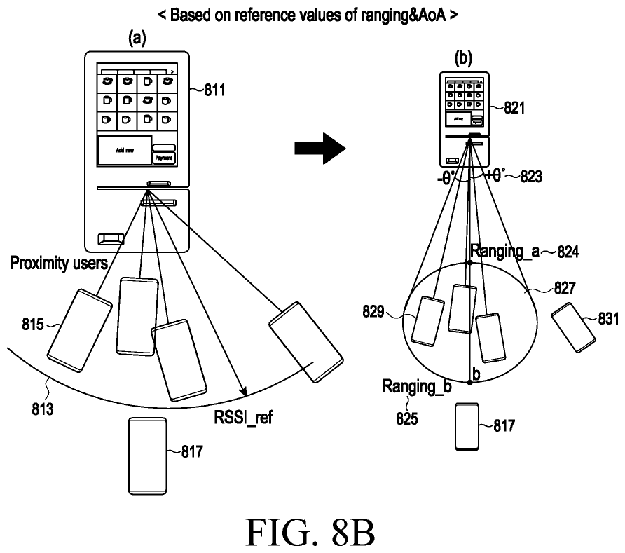

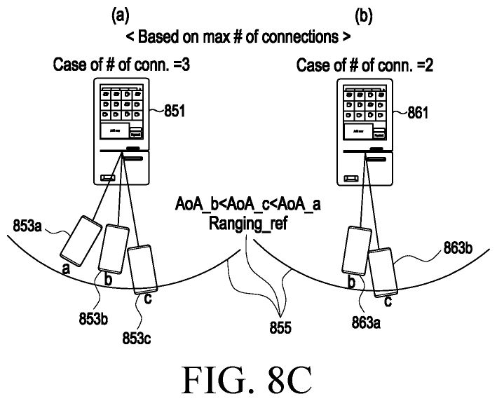

FIG. 8A illustrates a phase of a proximity payment method of an electronic device according to an embodiment of the disclosure. FIG. 8B illustrates a method of determining a pay-zone according to an embodiment of the disclosure. FIG. 8C illustrates another method of determining the pay-zone according to an embodiment of the disclosure.

A payment terminal and at least one electronic device (or user) of FIGS. 8A to 8C may be a (UWB) electronic device of FIGS. 1 to 5 or a payment terminal and at least one electronic device of FIGS. 6 and 7.

Referring to FIG. 8A, a first payment terminal (or a kiosk) 801 and a second payment terminal 802 may transmit a UWB and/or BLE advertisement message (or a UWB initiation message) to a first electronic device 803 and a second electronic device 804 in S805. The electronic devices 803 and 804 receiving the advertisement (or initiation message) from the payment terminals 801 and 802 may execute an application for performing payment in S810.

A plurality of electronic devices 803 and 804 executing the application may measure an AoA and a strength of a signal (for example, RSSI), based on the message (UWB advertisement message or UWB initiation message) received from the payment terminals 801 and 802 in S815. After determining the AoA and the strength of the signal (RSSI) from the payment terminals 801 and 802, the electronic devices 803 and 804 may determine whether the determined AoA indicates 0 degrees (0°) and the strength of the signal is higher than or equal to a predetermined threshold value). According to an embodiment, when the measured AoA is 0 degrees, the plurality of electronic devices 803 and 804 may determine that the corresponding electronic device exactly faces the payment terminals 803 and 804, which may be used to identify that the electronic device has an intention to pay other than determined due to reflection or refraction based thereon, Further, when the strength of the signal is higher than or equal to a predetermined threshold value, the plurality of electronic devices 803 and 804 may determine how close the electronic devices are to the payment terminals 801 and 802. The threshold value of the strength of the signal may be included in a UWB advertisement or UWB initiation message transmitted by the payment terminals 801 and 802 in S805. The UWB advertisement or UWB initiation message in S805 may include an indicator indicating transmission of a response message to the plurality of electronic devices 803 and 804 when the measured strength of the signal is higher than or equal to the threshold value of the strength of the signal. According to an embodiment, the payment terminals 801 and 802 may transmit the UWB initiation message separately from the UWB advertisement and, when the threshold value of the strength of the signal and the indicator indicating transmission of the response message when the strength of the signal is higher than or equal to the threshold value of the strength of the signal are not included in the UWB advertisement, the threshold value of the strength of the signal and the indicator indicating transmission of the response signal when the strength of the signal is higher than or equal to the threshold of the strength of the signal may be included in the UWB initiation message. According to another embodiment, when the UWB initiation message is transmitted separately from the UWB advertisement, the threshold value of the strength of the signal is included in the UWB advertisement and the indicator indicating transmission of the response signal when the strength of the signal is higher than or equal to the threshold value of the strength of the signal may be separately included in the UWB initiation message.

When the AoA measured based on the received signal is 0 degrees and the measured strength of the signal exceeds a predetermined threshold value (or larger than or equal to), the plurality of electronic devices 803 and 804 may transmit the response message to the corresponding payment terminal in S820. In FIG. 8A, it is illustrated that the plurality of electronic devices 803 and 804 transmits a response message to the second payment terminal 802.

When receiving the response message from the plurality of electronic devices 803 and 804, the second payment terminal 802 may identify the maximum number of connectable electronic devices and determine a ranging reference value and an AoA reference value through the received response message in S825. In an embodiment, the ranging reference value and the AoA reference value may be predetermined. In an embodiment, the ranging reference value and the AoA reference value may be determined based on the maximum number of connectable devices. In an embodiment, the ranging reference value and the AoA reference value may also be determined based on a response message to a UWB initiation message transmitted separately from the response message.

In another embodiment, the maximum number of connectable devices may be determined based on the determined ranging reference value and AoA reference value.

The second payment terminal 802 may perform ranging and measure the AoA, based on the received response message in S830 The second payment terminal 802 may measure distance information indicating the distance of each of the electronic devices 803 and 804 which transmitted the response message from the second payment terminal 802 by performing ranging. The second payment terminal 802 may measure the angle of each of the electronic devices 803 and 804 which transmitted the response message with respect to the second payment terminal 802 through AoA measurement. The second payment terminal 802 may determine the location of each of the electronic devices 803 and 804 from the second payment terminal 802, based on the distance information measured through the ranging and the angle information measured through the AoA measurement.

In S835, the second payment terminal 802 may determine pay-zone, based on the AoA reference value (for example, −Θ° to +Θ°) and ranging reference value (for example, the ranging reference value may be from Ranging_a to Ranging_b corresponding to a distance value range that is longer than a distance value of Ranging_a from the payment terminal and is shorter than another distance value of Ranging_b, Ranging_a being 0) determined in S825. According to an embodiment, based on a predetermined threshold value, an electronic device having a ranging value and/or AoA value having a value smaller than the predetermined threshold value may be determined as a size boundary of the pay-zone among the plurality of electronic devices 803 and 804. Electronic devices included in the pay-zone may be identified by performing comparison with the size of the pay-zone in S835, based on the distance information of each of the electronic devices 803 and 804 and AoA information measured in S830.

The second payment terminal 802 may transmit a message including a connection result to at least one electronic device included in pay-zone in S840. The message including the connection result may include information related to payment. For example, the message including the connection result may include a payer identifier, payment details, and information for payment confirmation.

At least one electronic device 803 and 804 receiving the connection result from the second payment terminal 802 may determine whether to perform payment, based on the information related to payment included in the received message in S845. According to an embodiment, when the plurality of electronic devices 803 and 804 receives the message including the connection result, an electronic device first performing payment configuration may be determined to perform payment. According to another embodiment, when payment confirmation is performed by the plurality of electronic devices 803 and 804 for a predetermined time, it may be configured to separately perform payment according to the number of electronic devices performing payment confirmation. It is possible to support the will of a plurality of users to select payment by giving opportunities to a plurality of electronic devices located at a predetermined distance from the payment terminals 801 and 802. Only one user is not selected for payment, but the payment opportunities are provided to a plurality of users located near the payment terminal, thereby increasing accessibility for payment and promoting user convenience.

At least one electronic device 803 and 804 determining to perform payment may make a secure connection with the payment terminal 802 and proceed to payment in S850. The performed payment method may refer to the secure ranging phase 520 and the payment transaction phase 530 of FIG. 5.

FIG. 8B illustrates in detail a method (a) of determining whether the electronic device is in proximity to the payment terminal, based on the strength of the signal described in FIG. 8A and a method of determining the pay-zone, based on the AoA reference value and ranging reference value information according to an embodiment of the disclosure.

Referring to part (a) of FIG. 8B, at least one electronic device 815 and 817 may measure the AoA and the strength of a signal, based on a message received from the payment terminal 811. It may be determined that an electronic device having the measured strength of the signal (for example, RSSI) larger than a signal strength threshold value RSSI_ref is located within a boundary 813 of distances at which electronic devices having the signal strength of RSSI_ref may be located. The electronic device 815 within the boundary 813 of the distances corresponding to RSSI_ref and having the AoA of 0 degrees may transmit a response message to the payment terminal 811. The electronic device 817 which is not included in RSSI_ref 813 may not transit the response message to the payment terminal 811 although the measured AoA is 0 degrees. The threshold value of the strength of the signal may be transmitted by the payment terminal 811 or may be stored in each electronic device by a business operator from the beginning.

Referring to part (b) of FIG. 8B, the payment terminal 821 may determine a pay-zone 827, based on an AoA reference value 823 and ranging reference values (for example, a first ranging value (ranging_a) 824 and a second ranging reference value (ranging_b) 825). The payment terminal may transmit a matching result message only to an electronic device 829 included in the determined pay-zone 827 among at least one electronic device 829 and 831 transmitting the response message. For example, the electronic device 829 included in the pay-zone among the electronic devices 815 transmitting the response message in part (a) of FIG. 8B may receive the matching result message including payment information from the payment terminal, but the electronic device 831 which is not included in the pay-zone may receive the matching result message. The AoA reference value 823 and the ranging reference value 825 may be predetermined by settings, based on response messages received from at least one electronic device.

FIG. 8C illustrates a method of determining a pay-zone, based on the maximum number of connected electronic devices according to an embodiment of the disclosure.

Referring to part (a) of FIG. 8C, a payment terminal 851 may identity a plurality of electronic devices transmitting a response message. The payment terminal 851 may determine whether each of the plurality of electronic devices is located within a predetermined distance, based on a ranging reference value 855. In accordance with the number 3 corresponding to the predetermined maximum connection limit among the plurality of electronic devices located within the predetermined distance, the payment terminal 851 may transmit a message including payment information to three electronic devices 853a, 853b, and 853c in the order of small AoA. In this case, information on the pay-zone may include an AoA value (AoA_a) of the electronic device 853a having the largest AoA value as the AoA reference value and include Ranging_ref 855 as the ranging reference value. The maximum number of connection limits may be a preset value.

In the same situation, in the case of part (b) of FIG. 8C, the payment terminal 861 may determine electronic devices located with a predetermined distance, based on the ranging reference value 855. In accordance with the number 2 corresponding to the predetermined maximum connection limit among the plurality of electronic devices located within the predetermined distance, the payment terminal 861 may transmit a message including payment information to two electronic devices 863a and 863b in the order of small AoA. In this case, information on the pay-zone may include an AoA value (AoA_c) of the electronic device 863a having the largest AoA value and include Ranging_ref 855 as the ranging reference value.

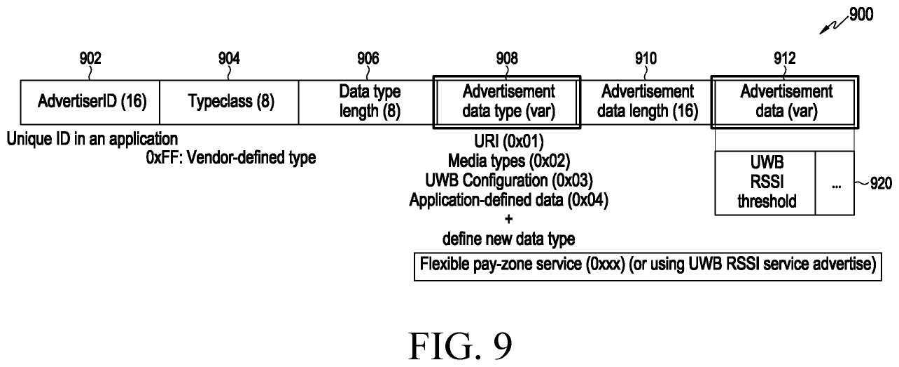

FIG. 9 illustrates the format of a UWB advertisement message according to an embodiment of the disclosure.

In FIG. 9, the UWB advertisement message may be a UWB message including advertisement data. As an embodiment, the message may be a UWB initiation message for initiating UWB TWR instead of the UWB advertisement message in order to measure the AoA and the strength of the signal by the electronic device. In FIG. 9, the UWB advertisement message may indicate the UWB advertisement in FIGS. 6 to 8A of the disclosure.

In an embodiment, the UWB advertisement message may include at least one of an AdvertisementID field 902, a Typeclass field 904, a Data type length field 906, an Advertisement data type field 908, an Advertisement data length field 910, and an Advertisement data field 912.

The AdvertisementID field 902 may indicate an identifier of an application providing a service. The Typeclass field 904 may indicate the definition of a large classification unit indicating which type the advertisement data is. The Data type length field 906 indicates the length of an advertisement data type. The Advertisement data type field 908 indicates detailed data required for a part defined in the Typeclass field 904. The Advertisement data length field 910 indicates the length of advertisement data. The Advertisement data field 912 includes data to be advertised.

For example, the format of the UWB advertisement message may be as shown in the following table.

TABLE 1

| Parameter | Size(bits) | Notes |
|---|---|---|
| AdvertiserID | 16 | Unique ID in an application |
| TypeClass | 8 | A class of data format |
| | | contained in Advertisement |
| | | Data |
| | | 0x00: RFU |
| | | 0x01: URI as defined in RFC |
| | | 3986 |
| | | 0x02: Media Types as |
| | | defined in RFC 2046 |
| | | 0x03: UWB configuration |
| | | parameter |
| | | 0x04: Application-defined |
| | | data (or OS-defined data) |
| | | 0x05-0xFE: RFU |
| | | 0xFF: Vendor-defined type |
| a Type Length | 8 | Length of Advertisement |
| | | Data Type field (in octets) |
| Advertisement Data Type | Variable | If TypeClass == URI(0x01), |
| | | absolute URI as defined in |
| | | [RFC 3986]. |
| | | If TypeClass == Media |
| | | Types (0x02), media type as |
| | | defined in [RFC 2046]. |
| | | If TypeClass == UWB |
| | | Configuration (0x03), data |
| | | type as defined in CSML |
| | | spec v1.0 section x.x.x. |
| | | If TypeClass == |
| | | Application-defined data |
| | | (0x04), a string that contains |
| | | one or more identifier(s). |
| | | Each identifier shall be a |
| | | string concatenating |
| | | Operating System (OS) |
| | | identifier, slash (‘/’), and the |
| | | application identifier |
| | | corresponding to that OS |
| | | identifier. If the string |
| | | contains more than two |
| | | identifiers, ‘$’ shall be used |
| | | as a delimiter. (e.g. |
| | | “OS_ID_1/App_ID_1$OS_ID_{—} |
| | | 2/App_ID_{—} |
| | | 2$OS_ID_3/App_ID_3)” |
| | | OS identifier is the |
| | | string format data and can be |
| | | one of the followings: |
| | | “Android” |
| | | “iOS” |
| | | “Tizen” |
| Advertisement Data | 16 | Length of Advertisement |
| Length | | Data field (in octets) |
| Advertisement Data | Variable | Data which of type |
| | | corresponds to Type field |

Referring to [Table 1] above, for example, the URI may be inserted into the advertisement data type and used when TypeClass is URI (0x01), and a detailed media type value (for example, text, image, or audio) may be inserted into the advertisement data type and thus it may be known which media type data is the next advertisement data when TypeClass is a media type (0x02). The advertisement data of the disclosure defines to inform of the use of a Vendor-defined type (0xFF) in the TypeClass and a Flexible pay-zone in the Advertisement Data Type, and thus it may be noted that the advertisement data includes a UWB RSSI threshold and data required for a UWB connection.

According to an embodiment, the Advertisement data type field 908 may include information related to a pay-zone service as a new data type. The information related to the pay-zone service may include information indicating that the corresponding Advertisement message is a message for UWB RSSI service advertisement.

According to an embodiment, the UWB advertisement message may include information or a field indicating a threshold value of the strength of a signal (for example, RSSI). This may be represented as a UWB RSSI threshold value 920. The strength of the signal is not limited to the RSSI.

According to an embodiment, the information or field indicating the UWB RSSI threshold value 920 may be included in at least one of an AdvertisementID field 902, a Typeclass field 904, a Data type length field 906, an Advertisement data type field 908, an Advertisement data length field 910, and an Advertisement data field 912.

According to an embodiment, the UWB advertisement message may include an indicator indicating transmission of the response message to the electronic device receiving the message when the measured strength of the signal is larger than the UWB RSSI threshold value 920 and indicating non-transmission of the response message when the strength is not larger than the same. The indicator may be included in at least one of the AdvertisementID field 902, the Typeclass field 904, the Data type length field 906, the Advertisement data type field 908, the Advertisement data length field 910, and the Advertisement data field 912.

The information is not limited to the UWB advertisement message and may be understood as the format of the UWB initiation message.

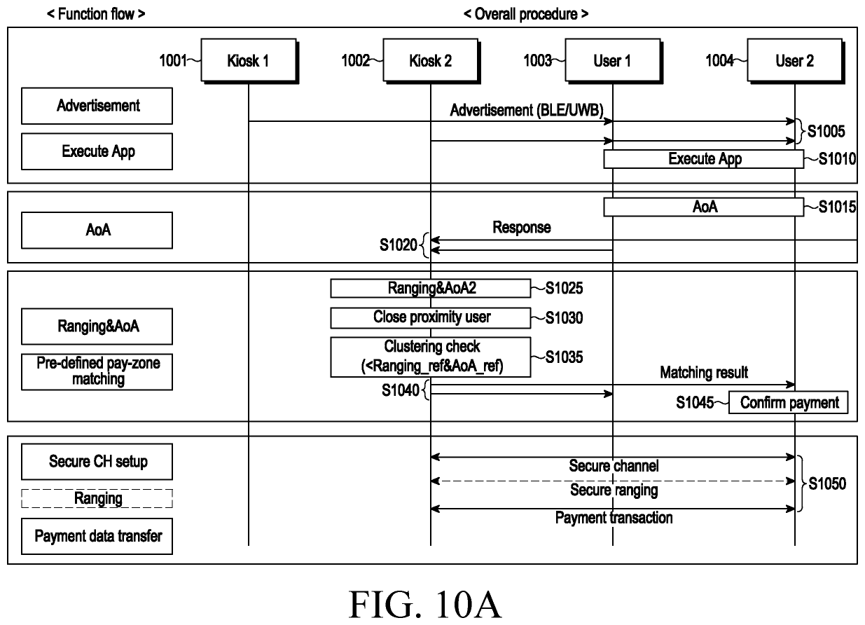

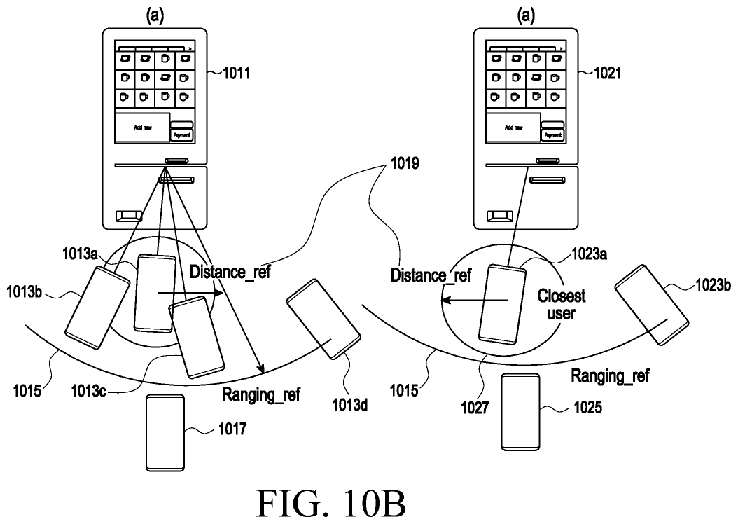

FIG. 10A illustrates the phase of the proximity payment method of the electronic device according to another embodiment of the disclosure. FIG. 10B illustrates a method of determining a payer and a pay-zone according to an embodiment of the disclosure.

A payment terminal and at least one electronic device (or user) of FIGS. 10A to 10B may be the (UWB) electronic device of FIGS. 1 to 9 or the payment terminal and at least one electronic device of FIGS. 6 to 9.

Referring to FIG. 10A, a first payment terminal (or a kiosk) 1001 and a second payment terminal 1002 may transmit a UWB or BLE advertisement message (or a UWB initiation message) to a first electronic device (or a user device) 1003 and a second electronic device 1004 in S1005. The electronic devices 1003 and 1004 receiving the advertisement message (or initiation message) from the payment terminals 1001 and 1002 may execute an application for performing payment in S1010.

According to an embodiment, the payment terminals 1001 and 1002 may transmit the UWB initiation message separately from the UWB advertisement and, when the threshold value of the strength of the signal and the indicator indicating transmission of the response message when the strength of the signal is higher than or equal to the threshold value of the strength of the signal are not included in the UWB advertisement, the threshold value of the strength of the signal and the indicator indicating transmission of the response signal when the strength of the signal is higher than or equal to the threshold of the strength of the signal may be included in the UWB initiation message. According to another embodiment, when the UWB initiation message is transmitted separately from the UWB advertisement, the threshold value of the strength of the signal is included in the UWB advertisement and the indicator indicating transmission of the response signal when the strength of the signal is higher than or equal to the threshold value of the strength of the signal may be separately included in the UWB initiation message.

The plurality of electronic devices 1003 and 1004 executing the application may measure the AoA, based on the message received from the payment terminals 1001 and 1002 in S1015. After determining the AoA, the plurality of electronic devices 1003 and 1004 may determine whether the determined AoA is 0 degrees (0°). According to an embodiment, when the measured AoA is 0 degrees, the plurality of electronic devices 1003 and 1004 may determine that the corresponding electronic device exactly faces the payment terminals 1001 and 1002, which may be used to identify that the electronic device has an intention to pay other than determined due to reflection or refraction based thereon,

The response message may be transmitted to the corresponding payment terminal of which the measured AoA is 0 degrees, based on the received signal, among the plurality of electronic devices 1003 and 1004 in S1020. FIG. 10A illustrates a situation in which the plurality of electronic devices 1003 and 1004 transmits the response message to the second payment terminal 1002.

The second payment terminal 1002 may perform ranging, based on the response messages received from the plurality of electronic devices 1003 and 1004 and measure the AoA in S1025. The second payment terminal 1002 may measure distance information indicating the distance of each of the electronic devices 1003 and 1004 which transmitted the response message from the second payment terminal 1002 by performing ranging. The second payment terminal 1002 may identify the angle of each of the electronic devices 1003 and 1004 which transmitted the response message with respect to the second payment terminal 1002 through the AoA measurement.

The second payment terminal 1002 may select the electronic device, based on a ranging reference value (for example, Ranging_ref) determined in advance or acquired through the response message. In S1030, an electronic device located closest to the payment terminal 1002 may be determined among the electronic devices located at a distance closer to the ranging reference value, based on the ranging information of the at least one electronic device acquired in step S1025.

Based on the closest electronic device, the second payment terminal 1002 may identify electronic devices constituting a cluster therearound in S1035. In order to identify the electronic devices constituting the cluster, a ranging result (distance information) may be used. According to an embodiment, an electronic device within an arbitrary reference distance (for example, Distance_ref) radius from the closest electronic device may be identified by a method of determining the cluster. According to an embodiment, an arbitrary reference distance (for example, Distance_ref) radius from the closest electronic device may be determined as the pay-zone.

The second payment terminal 1002 may transmit a connection result message including information related to payment to an electronic device within the arbitrary reference distance (for example, Distance_ref) radius in S1035. For example, the connection result message may include a payer identifier, payment details, and information for payment confirmation. In FIG. 10A, it is illustrated that the first electronic device 1003 and the second electronic device 1004 are included.

The electronic devices 1003 and 1004 receiving the connection result from the second payment terminal 1002 may determine whether to perform payment, based on the information related to payment included in the received message in S1045. According to an embodiment, when the plurality of electronic devices 1003 and 1004 receives the connection result message, the electronic device that first performs payment confirmation may be determined to perform payment. According to another embodiment, when payment confirmation is performed by a plurality of electronic devices for a predetermined time, it may be configured to separately perform payment according to the total number of electronic devices that have performed payment confirmation.

Thereafter, at least one electronic device 1003 and 1004 determined to perform payment may make a secure connection with the payment terminal 1002 and proceed to payment in S1050. The performed payment method may refer to the secure ranging phase 520 and the payment transaction phase 530 of FIG. 5, or S850 of FIG. 8.

FIG. 10B shows in detail the method (a) of identifying electronic devices, based on the closest electronic device and the cluster described in FIG. 10A and the method (b) of determining the payment zone within a predetermined radius, based on the closest electronic device described in FIG. 10A according to an embodiment of the disclosure.

Referring to part (a) of FIG. 10B, the payment terminal 1011 may identify at least one electronic device 1013a, 1013b, 1013c, 1013d, and 1017 transmitting the response message. The payment terminal 1011 may select an adjacent electronic device through a ranging reference value (for example, Ranging_ref) 1015 determined in advance or acquired based on the response message. The payment terminal 1011 may identify the electronic devices 1013a, 1013b, 1013c, and 1013d located within the predetermined distance 1015 from the payment terminal 1011 determined based on the ranging reference value. The payment terminal 1011 may identify the closest electronic device 1013a, based on ranging information measured based on the response message among the electronic devices 1013a, 1013b, 1013c, and 1013d located within a predetermined distance. The payment terminal 1011 may recognize the electronic devices 1013a, 1013b, and 1013c within an arbitrary reference distance (for example, Distance_ref) radius as one cluster, based on the closest electronic device 1013a and identify the same. The payment terminal 1011 may make the connection to the electronic devices 1013a, 1013b, and 1013c within an arbitrary reference distance radius and transmit a message including information related to payment.

Referring to part (b) of FIG. 10B, the payment terminal 1021 may identify at least one electronic device 1023a, 1023b, or 1025 transmitting the response message. The payment terminal 1021 may select an adjacent electronic device through a ranging reference value (for example, Ranging_ref) 1015 determined in advance or acquired based on the response message. The payment terminal 1021 may identify the electronic devices 1023a and 1023b located within the predetermined distance 1015 from the payment terminal 1021 determined based on the ranging reference value. The payment terminal 1021 may identify the closest electronic device 1023a, based on the ranging information measured based on the response message among the electronic devices 1023a and 1023b located within the predetermined distance. The payment terminal 1021 may determine a range within an arbitrary reference distance (e.g., distance_ref) radius as a payment zone 1027 based on the closest electronic device 1013a. The payment terminal 1021 may make the connection with an electronic device within the determined payment zone 1027 and transmit a message including information related to payment. According to an embodiment, the payment terminal 1021 may make the connection only to the closest electronic device among the electronic devices within the determined payment zone 1027.

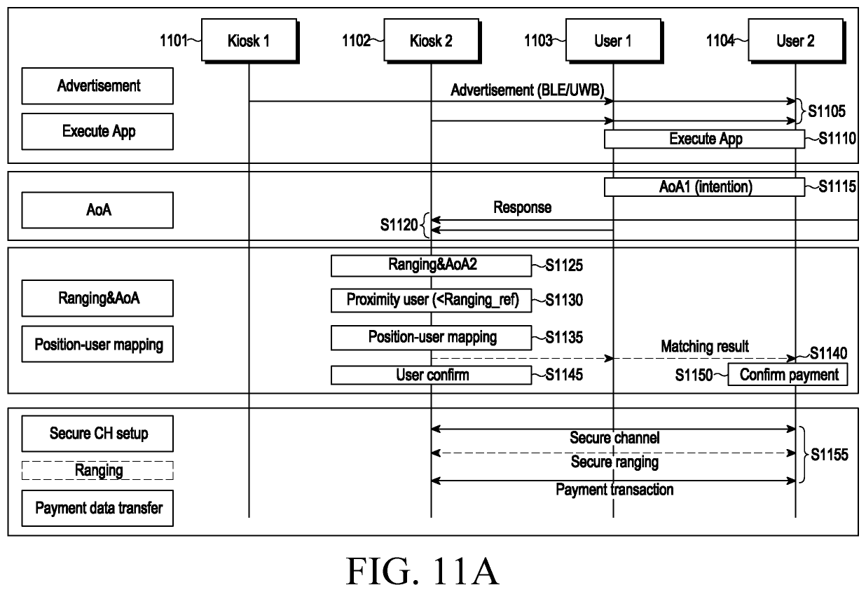

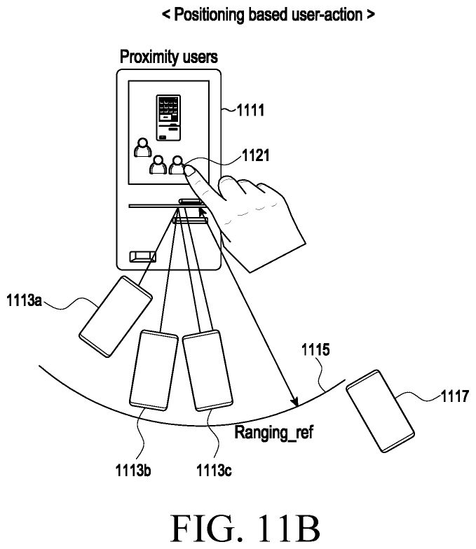

FIG. 11A illustrates the phase of the proximity payment method of the electronic device according to another embodiment of the disclosure. FIG. 11B illustrates a method of determining a payer and a pay-zone according to an embodiment of the disclosure.

A payment terminal and at least one electronic device (or user) of FIGS. 11A to 11B may be the (UWB) electronic device of FIGS. 1 to 10 or the payment terminal and at least one electronic device of FIGS. 6 to 10.

Referring to FIG. 11A, a first payment terminal (or kiosk) 1101 and a second payment terminal 1102 may transmit a UWB or BLE advertisement message (or a UWB or BLE initiation message) to a first electronic device (or user device) 1103 and a second electronic device 1104 in S1105. The electronic devices 1103 and 1104 receiving the advertisement message (or initiation message) from the payment terminals 1101 and 1102 may execute an application for performing payment in S1110.

According to an embodiment, the payment terminals 1101 and 1102 may transmit the UWB initiation message separately from the UWB advertisement and, when the threshold value of the strength of the signal and the indicator indicating transmission of the response message when the strength of the signal is higher than or equal to the threshold value of the strength of the signal are not included in the UWB advertisement, the threshold value of the strength of the signal and the indicator indicating transmission of the response signal when the strength of the signal is higher than or equal to the threshold of the strength of the signal may be included in the UWB initiation message. According to another embodiment, when the UWB initiation message is transmitted separately from the UWB advertisement, the threshold value of the strength of the signal is included in the UWB advertisement and the indicator indicating transmission of the response signal when the strength of the signal is higher than or equal to the threshold value of the strength of the signal may be separately included in the UWB initiation message.

The plurality of electronic devices 1103 and 1104 executing the application may measure the AoA, based on the message received from the payment terminals 1101 and 1102 in S1115. After determining the AoA, the plurality of electronic devices 1103 and 1104 may determine whether the determined AoA is 0 degrees). According to an embodiment, when the measured AoA is 0 degrees, the plurality of electronic devices 1103 and 1104 may determine that the corresponding electronic device exactly faces the payment terminals 1101 and 1102, which may be used to identify that the electronic device has an intention to pay other than determined due to reflection or refraction based thereon.

The response message may be transmitted to the corresponding payment terminal having the AoA of 0 degrees measured based on the received signal among the plurality of electronic devices 1103 and 1104 in S1120 . . . . FIG. 11A illustrates a situation in which the plurality of electronic devices 1103 and 104 transmits the response message to the second payment terminal 1102.

The second payment terminal 1102 may perform ranging, based on the response message received from the plurality of electronic devices 1103 and 1104 and measure the AoA in S1125. The second payment terminal 1102 may perform ranging to measure distance information indicating the location of each of the electronic devices 1103 and 1104, which transmitted the response message, from the second payment terminal 1102. The second payment terminal 1102 may identify the angle of each of the electronic devices 1103 and 1104 which transmitted the response message with respect to the second payment terminal 1102 through the AoA measurement.

The second payment terminal 1102 may select the electronic device, based on a ranging reference value (for example, Ranging_ref) determined in advance or acquired through the response message in S1030. Electronic devices closer to the ranging reference value may be determined based on the ranging information of the at least one electronic device acquired in step S1125.

In S1135, the second payment terminal 1102 may map each of the electronic devices, based on the locations of the electronic devices selected in step S1130. The second payment terminal 1102 may provide the location of the electronic device on the display, based on the mapped result. A user icon displayed on the display may be expressed as a person icon or a type of electronic device.

According to an embodiment, the second payment terminal 1102 may transmit a matching result message including payment information to the electronic device through the mapping result in S1140.

For the electronic device displayed on the display in S1135, the user of each electronic device may identify his/her location and touch or select a user icon to perform an operation for payment of the electronic device in S1145. The second payment terminal 1102 may transmit a message including information related to payment to the selected electronic device.

The electronic device 1104 selected in S1145 and receiving the message including the information related to payment from the second payment terminal 1102 may determine whether to perform a payment, based on the information related to payment included in the received message in S1150. According to an embodiment, when a plurality of electronic devices 1103 and 1104 is selected, the electronic device that first performs payment confirmation may be determined to perform payment. According to another embodiment, when a plurality of electronic devices is selected in S1145, it may be configured to separately perform payment according to the total number of the selected electronic devices.

Thereafter, the at least one electronic device 1104 that has determined to perform the payment may make a secure connection with the second payment terminal 1102 and proceed to the payment in S1155. The performed payment method may refer to the secure ranging phase 520 and the payment transaction phase 530 of FIG. 5, S850 of FIG. 8A, or S1050 of FIG. 10A.

FIG. 11B illustrates in detail a method of selecting a payer among from a plurality of electronic devices determined based on the ranging information described in FIG. 11A according to an embodiment of the disclosure.

Referring to FIG. 11B, the payment terminal 1111 may identify at least one electronic device 1113a, 1113b, 1113c, and 1117 that has transmitted the response message. The payment terminal 1111 may select an adjacent electronic device through a ranging reference value (for example, Ranging_ref) 1115 determined in advance or acquired based on the response message. The payment terminal 1111 may identify the electronic devices 1113a, 1113b, and 1113c located within the predetermined distance 1115 from the payment terminal 1111 determined based on the ranging reference value and make a connection. The payment terminal 1111 may map the locations of the electronic devices 1113a, 1113b, and 1113c located within the predetermined distance with the electronic device. The payment terminal 1111 may represent the mapped electronic devices 1113a, 1113b, and 1113c as user icons 1121 on a display. According to an embodiment, user nicknames may be displayed on the user icons 1121. The user of the electronic device may check the displayed user icon and select an electronic device to make payment. The selected electronic device may be at least one electronic device, and the selected electronic device may receive a message including information related to the payment from the payment terminal 1111. Upon receiving the message including the information related to the payment, the electronic device may determine whether to perform payment. When a plurality of electronic devices is selected, payment may be separately performed through a total number of selected electronic devices.

In accordance with an embodiment of the disclosure according to FIGS. 1 to 11B described above, a method of a first electronic device for processing payment using UWB communication may include an operation of broadcasting a first signal including a UWB advertisement message including information on a threshold value related to a signal strength, the UWB advertisement message being used as a UWB initiation message for initiating UWB two-way ranging (TWR) and the advertisement message being replaced with the UWB initiation message for initiating the UWB TWR, an operation of receiving a second signal including a UWB response message from at least one second electronic device, an operation of measuring an angle of arrival (AoA) for the received second signal and performing the UWB TWR, based on the UWB response message included in the second signal, so as to identify a distance between the at least one second electronic device and the first electronic device, an operation of determining a pay-zone, based on the distance between the at least one second electronic device and the first electronic device and the AoA, and an operation of transmitting a third signal including information related to the payment to one or more second electronic devices included in the pay-zone among the at least one second electronic device.

The operation of determining the pay-zone may include determining the pay-zone such that a number of the one or more second electronic devices becomes equal to a predetermined maximum number of connected electronic devices.

The method may further include an operation of identifying reference ranging information and reference AoA information, an operation of identifying the one or more second electronic devices included in a second pay-zone determined based on the reference ranging information and the reference AoA information, and an operation of transmitting the third signal including the information related to the payment to the one or more second electronic devices included in the second pay-zone.

The operation of transmitting the third signal including the information related to the payment may include an operation of transmitting the third signal including the information related to the payment only to an electronic device closest to the first electronic device among at least one second electronic device included in the pay-zone.

The UWB advertisement message may include at least one of an AdvertisementID field, a Typeclass field, a Data field length field, an Advertisement data type field, an Advertisement data length field, and an Advertisement data field, and the threshold value of the signal strength may be included in the advertisement data field.

The signal strength may be a received signal strength indication (RSSI).

According to an embodiment of the disclosure, a method of a second electronic device for processing payment using UWB communication may include an operation of receiving a first signal including a UWB advertisement message including information on a threshold value related to a signals strength from a first electronic device, the UWB advertisement message being used as a UWB initiation message for initiating UWB two-way ranging (TWR), an operation of measuring an angle of arrival (AoA) and the signal strength, based on the first signal, an operation of determining whether the measured signal strength is larger than the threshold value related to the signal strength, an operation of, when the signal strength is larger than the threshold value related to the signal strength, transmitting a second signal including a UWB response message to the first electronic device, an operation of receiving a third signal including the information related to the payment from the first electronic device, and an operation of determining whether to perform the payment, based on the information related to the payment.

The signal strength may be a received signal strength indication (RSSI), the UWB advertisement message may include at least one of an AdvertisemenID field, a Typeclass field, a Data type length field, an Advertisement data type field, an Advertisement data length field, and an Advertisement data field, and the threshold value related to the signal strength may be included in the advertisement data field.

The operation of transmitting the second signal including the UWB response message to the first electronic device may include an operation of identifying whether the measured AoA is a preset specific angle and an operation of, only when the measured AoA is the preset specific angle, transmitting the second signal to the first electronic device.

The operation of determining whether to perform the payment may include an operation of, when a number of electronic devices determined to perform the payment is plural, performing the payment separately.

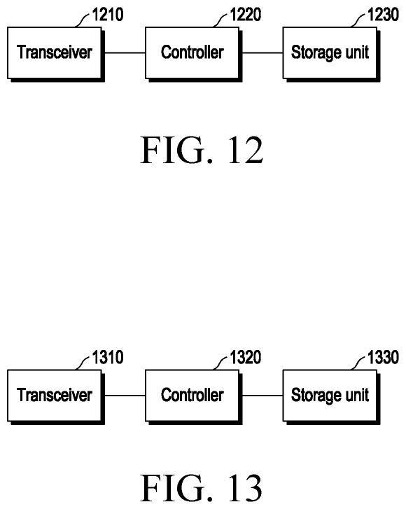

FIG. 12 is a diagram illustrating a structure of a first electronic device according to an embodiment of the disclosure.

In an embodiment of FIG. 12, the first electronic device may be a payment terminal. In an embodiment, the payment terminal may be a UWB support terminal.

Referring to FIG. 12, the first electronic device may include a transceiver 1210, a controller 1220, and a storage 1230. In the disclosure, the controller may be defined as a circuit, an application-specific integrated circuit, or at least one processor.

The transceiver 1210 may transmit and receive signals to and from another network entity. The transceiver 1210 may transmit and receive data for payment to and from the second electronic device using, for example, UWB communication.

The control unit 1220 may control the overall operation of the first electronic device according to an embodiment proposed in the disclosure. For example, the controller 1220 may control the signal flow between blocks to perform the operation in accordance with the flowchart described in FIGS. 1 to 11B of the disclosure. Specifically, the controller 1220 may control, for example, the operation of the payment terminal described with reference to FIGS. 1 to 11B.

The storage unit 1230 may store at least one piece of information transmitted and received through the transceiver 1210 and information generated through the controller 1220. For example, the storage unit 1230 may store information and data for processing proximity payment by using, for example, the UWB described with reference to FIGS. 1 to 11B

FIG. 13 is a diagram illustrating a structure of a second electronic device according to an embodiment of the disclosure.

In an embodiment of FIG. 13, the second electronic device may be an electronic device (or user device) including a payment application. In an embodiment, the second electronic device may be a UWB support electronic device (or application). In an embodiment of FIG. 13, the operation of the second electronic device may be understood as an operation of the payment application of the second electronic device.

Referring to FIG. 13, the second electronic device may include a transceiver 1310, a controller 1320, and a storage unit 1330. In the disclosure, the controller may be defined as a circuit, an application-specific integrated circuit, or at least one processor.

The transceiver 1310 may transmit and receive signals to and from another network entity. The transceiver 1310 may transmit and receive data for payment to and from the first electronic device by using, for example, UWB communication.

The controller 1320 may control the overall operation of the second electronic device according to an embodiment proposed in the disclosure. For example, the controller 1320 may control the signal flow between blocks to perform the operation in accordance with the flowchart described in FIGS. 1 to 11B of the disclosure. Specifically, the controller 1320 may control, for example, the operation of the electronic device described with reference to FIGS. 1 to 11B.

The storage unit 1330 may store at least one piece of information transmitted and received through the transceiver 1310 and information generated through the controller 1320. For example, the storage unit 1330 may store, for example, information and data for processing payment using the UWB described with reference to FIGS. 1 to 11B.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method of a first electronic device for processing payment using ultra-wide band (UWB) communication, the method comprising:
broadcasting a first signal including a UWB advertisement message including information on a threshold value related to signal strength, wherein the UWB advertisement message is used as a UWB initiation message for initiating UWB two-way ranging (TWR);
receiving, from at least one second electronic device, a second signal comprising a UWB response message;
measuring an angle of arrival (AoA) for the received second signal and performing UWB TWR, based on the UWB response message included in the second signal, so as to identify a distance between the at least one second electronic device and the first electronic device;
determining a pay-zone, based on the distance between the at least one second electronic device and the first electronic device, and the AoA; and
transmitting, to one or more second electronic devices included in the pay-zone among the at least one second electronic device, a third signal including information related to the payment.

2. The method of claim 1, wherein determining the pay-zone comprises determining the pay-zone such that a number of the one or more second electronic devices becomes equal to a predetermined maximum number of connected electronic devices.

3. The method of claim 1, further comprising:
identifying reference ranging information and reference AoA information;
identifying the one or more second electronic devices included in a second pay-zone determined based on the reference ranging information and the reference AoA information; and
transmitting the third signal including the information related to the payment to the one or more second electronic devices included in the second pay-zone.

4. The method of claim 1, wherein transmitting third signal including the information related to the payment comprises transmitting the third signal including the information related to the payment to an electronic device closest to the first electronic device among at least one second electronic device included in the pay-zone.

5. The method of claim 1, wherein the UWB advertisement message includes at least one of an AdvertisementID field, a Typeclass field, a Data field length field, an Advertisement data type field, an Advertisement data length field, and an Advertisement data field, and
wherein the threshold value of the signal strength is included in the advertisement data field.

6. The method of claim 1, wherein the signal strength is a received signal strength indication (RSSI).

7. A method of a second electronic device for processing payment using ultra-wide band (UWB) communication, the method comprising:
receiving, from a first electronic device, a first signal including a UWB advertisement message including information on a threshold value related to signal strength, wherein the UWB advertisement message is used as a UWB initiation message for initiating UWB two-way ranging (TWR);
measuring an angle of arrival (AoA) and signal strength, based on the first signal;
determining whether the measured signal strength is larger than the threshold value related to the signal strength;
in case that the signal strength is larger than the threshold value related to the signal strength, transmitting a second signal including a UWB response message to the first electronic device;
receiving a third signal including information related to the payment from the first electronic device; and
determining whether to perform the payment, based on the information related to the payment.

8. The method of claim 7, wherein the signal strength is a received signal strength indication (RSSI),
wherein the UWB advertisement message includes at least one of an AdvertisemenID field, a Typeclass field, a Data type length field, an Advertisement data type field, an Advertisement data length field, and an Advertisement data field, and
wherein the threshold value related to the signal strength is included in the advertisement data field.

9. The method of claim 7, wherein transmitting the second signal including the UWB response message to the first electronic device comprises:
identifying whether the measured AoA is a preset specific angle; and
in case that the measured AoA is the preset specific angle, transmitting the second signal to the first electronic device.

10. The method of claim 7, wherein determining whether to perform the payment comprises, in case that a number of electronic devices determined to perform the payment is plural, performing separate payment.

11. A first electronic device for processing payment using ultra-wide band (UWB) communication, the first electronic device comprising:
a transceiver; and
at least one processor,
wherein the at least one processor is configured to:
broadcast a first signal including a UWB advertisement message including information on a threshold value related to signal strength, wherein the UWB advertisement message is used as a UWB initiation message for initiating UWB two-way ranging (TWR),
receive, from at least one second electronic device, a second signal including a UWB response message,
measure an angle of arrival (AoA) for the received second signal and perform UWB TWR, based on the UWB response message included in the second signal, so as to identify a distance between the at least one second electronic device and the first electronic device,
determine a pay-zone, based on the distance between the at least one second electronic device and the first electronic device and the AoA, and
transmit, to one or more second electronic devices included in the pay-zone among the at least one second electronic device, a third signal including information related to the payment.

12. The first electronic device of claim 11, wherein the at least one processor is configured to:
determine the pay-zone such that a number of the one or more second electronic devices becomes equal to a predetermined maximum number of connected electronic devices.

13. The first electronic device of claim 11, wherein the at least one processor is further configured to:
identify reference ranging information and reference AoA information,
identify the one or more second electronic devices included in a second pay-zone determined based on the reference ranging information and the reference AoA information, and
transmit the third signal including the information related to the payment to the one or more second electronic devices included in the second pay-zone.

14. A second electronic device for processing payment using ultra-wide band (UWB) communication, the second electronic device comprising:
a transceiver; and
at least one processor,
wherein the at least one processor is configured to:
receive, from a first electronic device, a first signal including a UWB advertisement message including information on a threshold value related to signal strength, wherein the UWB advertisement message is used as a UWB initiation message for initiating UWB two-way ranging (TWR);
measure an angle of arrival (AoA) and signal strength, based on the first signal;
determine whether the measured signal strength is larger than the threshold value related to the signal strength;
in case that the signal strength is larger than the threshold value related to the signal strength, transmit a second signal including a UWB response message to the first electronic device;
receive a third signal including information related to the payment from the first electronic device; and
determine whether to perform the payment, based on the information related to the payment.

15. (canceled)

16. The first electronic device of claim 11, wherein the at least one processor is further configured to:
transmit the third signal including the information related to the payment to an electronic device closest to the first electronic device among at least one second electronic device included in the pay-zone.

17. The first electronic device of claim 11, wherein the UWB advertisement message includes at least one of an AdvertisementID field, a Typeclass field, a Data field length field, an Advertisement data type field, an Advertisement data length field, and an Advertisement data field, and
wherein the threshold value of the signal strength is included in the advertisement data field.

18. The first electronic device of claim 11, wherein the signal strength is a received signal strength indication (RSSI).

19. The second electronic device of claim 14,
wherein the signal strength is a received signal strength indication (RSSI),
wherein the UWB advertisement message includes at least one of an AdvertisemenID field, a Typeclass field, a Data type length field, an Advertisement data type field, an Advertisement data length field, and an Advertisement data field, and
wherein the threshold value related to the signal strength is included in the advertisement data field.

20. The second electronic device of claim 14, wherein the at least one processor is further configured to:
identify whether the measured AoA is a preset specific angle; and
in case that the measured AoA is the preset specific angle, transmit the second signal to the first electronic device.

21. The second electronic device of claim 14, wherein the at least one processor is further configured to:
in case that a number of electronic devices determined to perform the payment is plural, perform separate payment.
